(19) United States
(12) Patent Application Publication
(10) Pub. No.: US 2011/0242141 A1
(43) Pub. Date: Oct. 6, 2011

(54) OPTICAL SHEET LAMINATE BODY, ILLUMINATION UNIT, AND DISPLAY UNIT

(75) Inventors: Shigehiro Yamakita, Miyagi (JP); Ken Hosoya, Miyagi (JP); Noriyuki Hirai, Miyagi (JP); Taku Ishimori, Miyagi (JP); Hiroshi Hayashi, Miyagi (JP); Yoshiyuki Maekawa, Hokkaido (JP); Hiroshi Mizuno, Miyagi (JP); Daisuke Ito, Miyagi (JP)

(73) Assignee: SONY CORPORATION, Tokyo (JP)

(21) Appl. No.: 13/052,610

(22) Filed: Mar. 21, 2011

(30) Foreign Application Priority Data
Mar. 31, 2010 (JP) P2010-083096

(51) Int. Cl. G09G 5/10; G02B 1/10; G02B 5/30; F21V 9/14; B32B 37/02; B32B 38/00

(52) U.S. Cl. 345/690; 359/599; 359/485.01; 362/19; 156/60; 156/245

(57) ABSTRACT

An optical sheet laminate body includes: a first optical sheet having a top surface and a bottom surface, of which at least the top surface has asperities including projections and depressions; and a second optical sheet having a top surface and a bottom surface. Summits of the projections on the top surface of the first optical sheet are directly bonded, in a whole region facing the bottom surface of the second optical sheet, to the bottom surface of the second optical sheet without any intermediate material in between.

### CROSS REFERENCES TO RELATED APPLICATIONS

The present application claims priority to Japanese Priority Patent Application JP 2010-083096 filed in the Japan Patent Office on Mar. 31, 2010, the entire content of which is hereby incorporated by reference.

### BACKGROUND

The present application relates to an optical sheet laminate body in which a plurality of optical sheets are laminated, and an illumination unit, and a display unit that include the same.

A liquid crystal display unit including a thin and legible backlight (illumination unit) has been used as a display unit for a word processor, a laptop personal computer, or the like. As an illumination unit for the foregoing liquid crystal display unit, there are: an edge light type illumination unit in which a linear light source such as a fluorescent tube is arranged in a side end of a light guide plate, and in which, on this light guide plate, a liquid crystal panel is provided through a plurality of optical elements; and a directly type illumination unit in which a light source and a plurality of optical elements are arranged just under the liquid crystal panel, as disclosed in Japanese Unexamined Patent Application Publication No. 2005-301147 (JP2005-301147A).

The illumination unit for the liquid crystal display unit uses many optical elements with the aim of improving a view angle, a luminance, and the like. Examples of the optical element include, for example, a diffusion plate having an optical diffusion property, a prism sheet having a light collection property, and the like.

### SUMMARY

In association with a larger screen of the display unit in recent years, the area of the illumination unit is increased. In this case, the various optical sheets such as the prism sheet, and the diffusion plate are also requested to be larger in area. However, when the area of the optical sheet is increased, crinkle, deflection, and/or bowing are likely to occur due to its own weight. Also, in association with the larger area, an illuminance of a light source becomes higher in order to keep a brightness of a display surface. For this reason, although the heat applied to the surface of the optical sheet whose area is increased also increases, the heat is irregularly transmitted on the surface of the optical sheet. Thus, the deformation of the optical sheet caused by the heat is not regularly generated. As a result, the crinkle, the deflection, and/or the bowing are likely to occur due to the heat as well.

As a method of preventing the generation of the crinkle, the deflection, and/or the bowing of the optical sheet that are associated with the larger screen as mentioned above, for example, a method may be contemplated to make the optical sheet thick and to thereby improve the lack of a rigidity. However, when the foregoing method is employed, the illumination unit becomes thick, which prevents it from being made thinner. To address this, a method may be contemplated to entirely attach the optical sheets to each other with a transparent adhesive in lamination order, as described in JP2005-301147A, for example. By laminating the optical sheets through the transparent adhesive as mentioned above, it is possible to make the rigidity of the optical sheet high and to consequently prevent the generation of the crinkle, the deflection, and/or the bowing.

However, in the configuration in which the optical sheets are merely attached to each other through the transparent adhesive, a thickness increases corresponding to the thickness of the transparent adhesive. Thus, there is a possibility that the attainment of the thinner structure is prevented. Also, weight increases corresponding to the weight of the transparent adhesive, and thus there is also a possibility that the attainment of the lighter weight is prevented. Those issues are generated even when only the ends of the optical sheets are attached to each other with the adhesive, for example, as described in Japanese Unexamined Patent Application Publication No. H11-209807 (JP-H11-209807A).

It is desirable to provide an optical sheet laminate body capable of preventing generation of crinkle, deflection, and/or bowing, while attaining a thinner structure and lighter weight, and an illumination unit, and a display unit that include the same.

An optical sheet laminate body according to an embodiment includes: a first optical sheet having a top surface and a bottom surface, of which at least the top surface has asperities including projections and depressions; and a second optical sheet having a top surface and a bottom surface. Summits of the projections on the top surface of the first optical sheet are directly bonded, in a whole region facing the bottom surface of the second optical sheet, to the bottom surface of the second optical sheet without any intermediate material in between.

An illumination unit according to an embodiment includes: an optical sheet laminate body; and a light source emitting light toward the optical sheet laminate body. The optical sheet laminate body includes: a first optical sheet having a top surface and a bottom surface, of which at least the top surface has asperities including projections and depressions; and a second optical sheet having a top surface and a bottom surface. Summits of the projections on the top surface of the first optical sheet are directly bonded, in a whole region facing the bottom surface of the second optical sheet, to the bottom surface of the second optical sheet without any intermediate material in between.

A display unit according to an embodiment includes: an optical sheet laminate body; a display panel driven based on an image signal; and a light source illuminating the display panel via the optical sheet laminate body. The optical sheet laminate body includes: a first optical sheet having a top surface and a bottom surface, of which at least the top surface has asperities including projections and depressions; and a second optical sheet having a top surface and a bottom surface. Summits of the projections on the top surface of the first optical sheet are directly bonded, in a whole region facing the bottom surface of the second optical sheet, to the bottom surface of the second optical sheet without any intermediate material in between.

In each of the optical sheet laminate body, the illumination unit, and the display unit of the embodiments, the summits of the projections on the top surface of the first optical sheet are directly bonded, in the whole region facing the bottom surface of the second optical sheet, to the bottom surface of the second optical sheet without any intermediate material in between. In other words, an adhesive is not used to bond the first optical sheet and the second optical sheet. Also, the summits of the projections of the asperities in the whole region are bonded. Hence, an adherence property equivalent to that when optical sheets are attached to each other with the adhesive is obtained.

A manufacturing method of an optical sheet laminate body according to an embodiment includes the steps of: preparing a first optical sheet and a second optical sheet, the first optical sheet having a top surface and a bottom surface, of which at least the top surface has asperities including projections and depressions, and the second optical sheet having a top surface and a bottom surface; and directly bonding summits of the projections on the top surface of the first optical sheet, in a whole region facing the bottom surface of the second optical sheet, to the bottom surface of the second optical sheet without any intermediate material in between.

In the manufacturing method of the optical sheet laminate body according to the embodiment, the summits of the projections on the top surface of the first optical sheet are directly bonded, in the whole region facing the bottom surface of the second optical sheet, to the bottom surface of the second optical sheet without any intermediate material in between. In other words, an adhesive is not used to bond the first optical sheet and the second optical sheet. Also, the summits of the projections of the asperities in the whole region are bonded. Hence, an adherence property equivalent to that when optical sheets are attached to each other with the adhesive is obtained.

An optical sheet laminate body according to another embodiment includes: a first optical sheet having a top surface and a bottom surface, of which at least the top surface is flat; and a second optical sheet having a top surface and a bottom surface, of which at least the bottom surface is flat. The top surface of the first optical sheet are directly bonded, in a whole region facing the bottom surface of the second optical sheet, to the bottom surface of the second optical sheet without any intermediate material in between.

An illumination unit according to another embodiment includes: an optical sheet laminate body; and a light source emitting light toward the optical sheet laminate body. The optical sheet laminate body includes: a first optical sheet having a top surface and a bottom surface, of which at least the top surface is flat; and a second optical sheet having a top surface and a bottom surface, of which at least the bottom surface is flat. The top surface of the first optical sheet are directly bonded, in a whole region facing the bottom surface of the second optical sheet, to the bottom surface of the second optical sheet without any intermediate material in between.

A display unit according to another embodiment includes: an optical sheet laminate body; a display panel driven based on an image signal; and a light source illuminating the display panel via the optical sheet laminate body. The optical sheet laminate body includes: a first optical sheet having a top surface and a bottom surface, of which at least the top surface is flat; and a second optical sheet having a top surface and a bottom surface, of which at least the bottom surface is flat. The top surface of the first optical sheet are directly bonded, in a whole region facing the bottom surface of the second optical sheet, to the bottom surface of the second optical sheet without any intermediate material in between.

In each of the optical sheet laminate body, the illumination unit, and the display unit of another embodiments, the top surface of the first optical sheet are directly bonded, in the whole region facing the bottom surface of the second optical sheet, to the bottom surface of the second optical sheet without any intermediate material in between. In other words, an adhesive is not used to bond the first optical sheet and the second optical sheet. Also, the whole facing regions of the optical sheets are bonded. Hence, an adherence property equivalent to that when optical sheets are attached to each other with the adhesive is obtained.

According to the optical sheet laminate body, the illumination unit, the display unit, and the manufacturing method of the optical sheet laminate body of the embodiments, the summits of the projections on the top surface of the first optical sheet are directly bonded, in the whole region facing the bottom surface of the second optical sheet, to the bottom surface of the second optical sheet without any intermediate material in between. Therefore, it is possible to prevent generation of crinkle, deflection, and/or bowing, while attaining a thinner structure and lighter weight.

According to the optical sheet laminate body, the illumination unit, and the display unit of another embodiment, the top surface of the first optical sheet are directly bonded, in the whole region facing the bottom surface of the second optical sheet, to the bottom surface of the second optical sheet without any intermediate material in between. Therefore, it is possible to prevent generation of crinkle, deflection, and/or bowing, while attaining a thinner structure and lighter weight.

Additional features and advantages are described herein, and will be apparent from the following Detailed Description and the figures.

### BRIEF DESCRIPTION OF THE FIGURES

FIG. 1 is a cross section showing an example of an optical sheet laminate body according to a first embodiment.

FIG. 2 compares and indicates birefringence quantities (refractive index differences Δn) of optical sheets, which are manufactured by a melting extrusion manufacturing method and an embossed belt method.

FIG. 3A is a cross section showing a shape change that is caused by heating the optical sheet manufactured by the melting extrusion manufacturing method, and FIG. 3B is a cross section showing a shape change that is caused by heating the optical sheet manufactured by the embossed belt method.

FIG. 4 is a cross section showing a modification of the optical sheet laminate body of FIG. 1.

FIGS. 5A and 5B are cross sections showing another modification of the optical sheet laminate body of FIG. 1.

FIGS. 6A and 6B are cross sections showing still another modification of the optical sheet laminate body of FIG. 1.

FIG. 7 is a cross section showing an example of an optical sheet laminate body according to a second embodiment.

FIG. 8 is a cross section showing an example of an optical sheet laminate body according to a third embodiment.

FIGS. 9A and 9B are cross sections showing a modification of the optical sheet laminate body of FIG. 8.

FIGS. 10A and 10B are cross sections showing another modification of the optical sheet laminate body of FIG. 8.

FIG. 11 is a cross section showing still another modification of the optical sheet laminate body of FIG. 8.

FIG. 12 is a cross section showing still another modification of the optical sheet laminate body of FIG. 8.

FIGS. 13A and 13B are process drawings describing an example of a manufacturing method of each optical sheet included in each of the optical sheet laminate bodies shown in FIG. 1 and FIGS. 4 to 12.

FIG. 14 is a process drawing describing an example of a manufacturing method of each of the optical sheet laminate bodies shown in FIG. 1 and FIGS. 4 to 12.

FIG. 15 is a process drawing describing an example of a manufacturing method of an optical sheet laminate body of a three-layer structure.

FIG. 16 is a process drawing describing an example of a manufacturing method of an optical sheet laminate body of a four-layer structure.

FIG. 17 shows a relation between each optical sheet laminate body and a curl quantity.

FIGS. 18A and 18B are schematic drawings for describing a measuring method of the curl quantity of FIG. 17.

FIG. 19 shows an example of a heat roll temperature dependency property, in a relation between a luminance ratio and a 90-degree peel strength.

FIG. 20 shows an example of a heat roll temperature dependency property, in a relation between a bonding width and a luminance ratio.

FIG. 21 shows an example of a heat roll temperature dependency property, in a relation between the luminance ratio and a 90-degree peel strength.

FIG. 22 shows an example of a concave-convex pitch dependency property, in the relation between the luminance ratio and the 90-degree peel strength.

FIG. 23 shows an example of a relation between a bonding area ratio and the 90-degree peel strength.

FIGS. 24A and 24B are a perspective view and a cross section, respectively, of an optical element according to an application example.

FIG. 25 is a cross section of a display unit according to another application example.

### DETAILED DESCRIPTION

Embodiments of the present application will be hereinafter described in detail with reference to the drawings. The descriptions will be given in the following order.

### 1. First Embodiment (FIGS. 1 to 6B)

Structure

Effect

Modifications

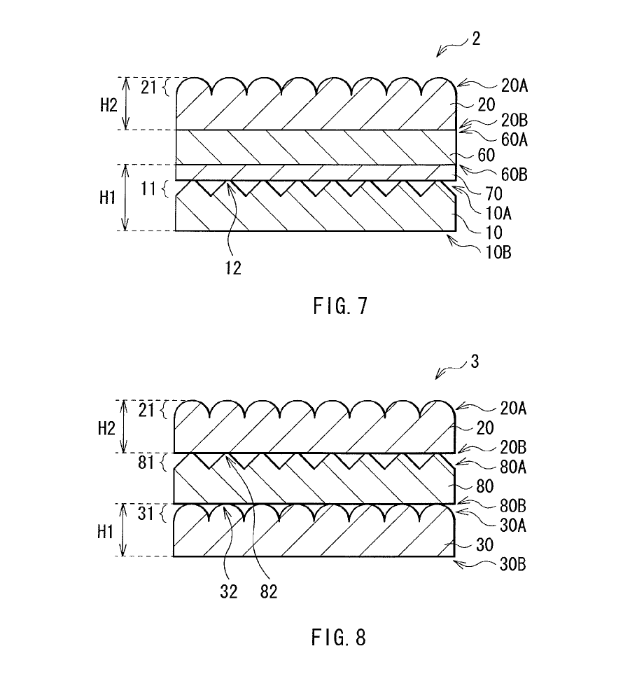

### 2. Second Embodiment (FIG. 7)

Structure

Effect

### 3. Third Embodiment (FIGS. 8 to 12)

Structure

Effect

Modification

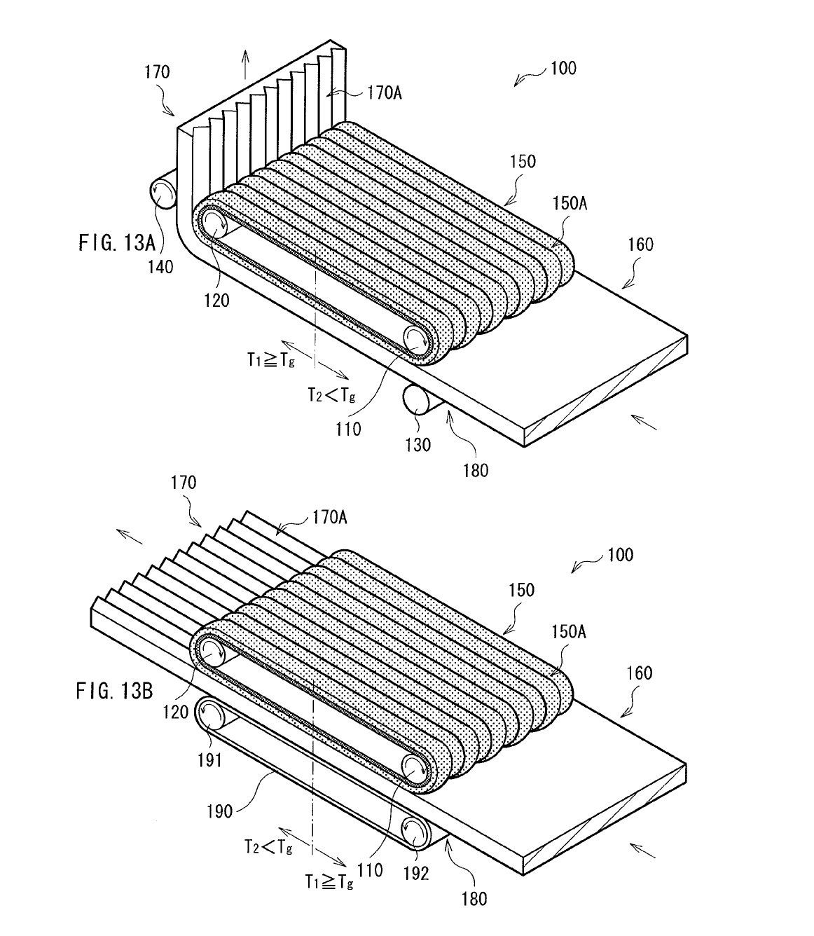

### 4. Manufacturing Methods (FIGS. 13A to 23)

Embossed Belt Manufacturing Method

Heat Lamination Manufacturing Method

Manufacturing Method When Optical Sheet of Three Layers Is Laminated

Manufacturing Method When Optical Sheet of Four Layers Is Laminated

Curl Quantity

Peel

Various Evaluations

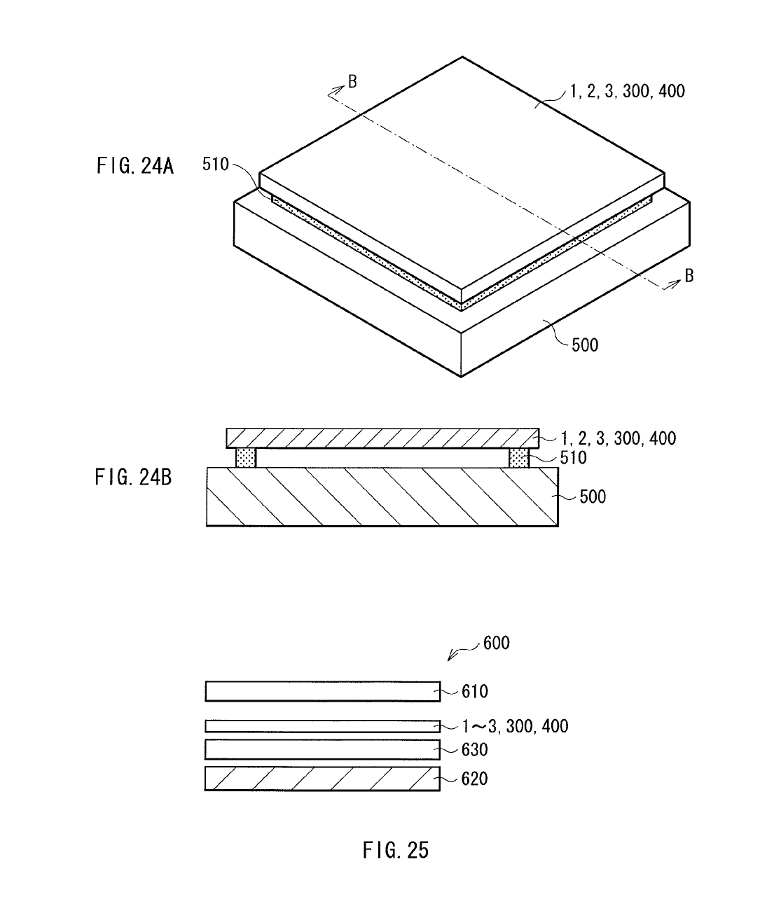

### 5. Application Examples (FIGS. 24A and 25)

### First Embodiment

### [Structure]

FIG. 1 shows an example of a sectional configuration of an optical sheet laminate body 1 according to a first embodiment. This optical sheet laminate body 1 is preferably used in an illumination unit, a backlight of a display unit, and the like, and includes a plurality of optical sheets.

The optical sheet laminate body 1 includes two optical sheets 10 and 20, for example, as shown in FIG. 1. The optical sheet 10 may be a rectangular resin sheet having a top plane (a top surface) 10A and a bottom plane (a bottom surface) 10B. The optical sheet 10 has asperities including projections and depressions (hereinafter simply referred to as “a concave-convex portion 11”) on the top plane 10A and a flat plane (flat surface) on the bottom plane 10B, for example, as shown in FIG. 1. The concave-convex portion 11 may be provided also on the bottom plane 10B, or a concave-convex portion different from the concave-convex portion 11 may be provided.

The concave-convex portion 11 is provided on the whole top plane 10A or partially thereof (for example, a region except edges out of the top plane 10A). The concave-convex portion 11 has a shape (concave-convex shape) in which a plurality of zonal prisms each having a triangular cross-section (triangular prisms) are arranged, for example. The concave-convex portion 11 may have a shape (concave-convex shape) in which a plurality of zonal prisms each having an aspheric cross-section (aspheric prisms) are arranged, for example. When the concave-convex portion 11 has the shape in which the plurality of triangular prisms or aspheric prisms are arranged as mentioned above, the optical sheet 10 functions as the prism sheet for collecting light incident from the bottom plane 10B side.

The optical sheet 10 may function as a vehicular diffusion sheet (an optical sheet having both of a light collection function and a light diffusion function), which has the concave-convex portion 11 and also has a light diffusion function entirely or partially. This light diffusion function may be isotropic or anisotropic. As a way for assigning the light diffusion function, for example, there is a method in which a filler is internally-added in the optical sheet 10, other than a shape assignment.

The optical sheet 20 may be the rectangular resin sheet having a top plane (a top surface) 20A and a bottom plane (a bottom surface) 20B, similarly to the optical sheet 10. The optical sheet 20 is arranged on the top plane 10A side of the optical sheet 10. The bottom plane 20B of the optical sheet 20 and the top plane 10A of the optical sheet 10 face each other. The optical sheet 20 has asperities including projections and depressions (hereinafter simply referred to as “a concave-convex portion 21”) on the top plane 20A and has a flat plane (a flat surface) on the bottom plane 20B, for example, as shown in FIG. 1. The top plane 20A may not have the concave-convex portion 21, and the top plane 20A may be flat.

The concave-convex portion 21 has a shape (concave-convex shape) in which, for example, a plurality of convexes (projections) that are spherical, aspheric, curved, or multifaceted are two-dimensionally arranged. The concave-convex portion 21 has a shape (concave-convex shape) in which, for example, similarly to the concave-convex portion 11, the triangular prisms or aspheric prisms are arranged. When the triangular prism or the aspheric prism is included in the concave-convex portion 11, the extending directions of the triangular prisms or aspheric prisms included in the concave-convex portion 21 and the concave-convex portion 11 preferably cross each other. When the concave-convex portion 21 has the shape in which the plurality of triangular prisms or aspheric prisms are arranged as mentioned above, the optical sheet 20 functions as the prism sheet for collecting the light incident from the bottom plane 20B side.

The optical sheet 20 may function as the diffusion sheet that has the light diffusion function entirely or partially, without having the concave-convex portion 21. Alternatively, the optical sheet 20 may function as the vehicular diffusion sheet (the optical sheet having both of the light collection function and the light diffusion function), which has the concave-convex portion 21 and also has the light diffusion function entirely or partially. This light diffusion function may be isotropic or anisotropic. As the way for assigning the light diffusion function, for example, there is the method in which the filler is internally-added in the optical sheet 10, other than the shape assignment.

The two optical sheets 10 and 20 are directly joined or bonded to each other without any interposition of an intermediate material such as an adhesive. Specifically, a whole region facing the bottom plane 20B of the optical sheet 20 out of a summit 12 of the concave-convex portion 11 and a whole region facing the summit 12 of the concave-convex portion 11 out of the bottom plane 20B of the optical sheet 20 are directly bonded to each other with thermal lamination. In other words, the summits 12 of the concave-convex portion 11 on the top plane 10A of the optical sheet 10 are directly bonded, in the whole region facing the bottom plane 20B of the optical sheet 20, to the bottom plane 20B of the optical sheet 20 without any intermediate material in between. As used herein, the term “thermal lamination” means that to-be-bonded materials are bonded (for example, thermally welled or thermally compressively bonded) by melting a part of the to-be-bonded material, without sandwiching a hot-melt adhesive film between the to-be-bonded materials. Also, the term “summit” 12 refers to a portion on which the edge line of the concave-convex portion 11 is formed.

Also, at least the optical sheet 10 out of the two optical sheets 10 and 20 is preferably fabricated by a manufacturing method in which plastic deformation resistant to the occurrence of distortion in a surface layer is dominant. For example, the optical sheet 10 may be fabricated through heating a mold (not shown) having an inversion pattern of the concave-convex portion (the asperities) 11 to a glass transition temperature of a resin material employed to form the optical sheet 10 or more, through pressing the inversion pattern against a resin layer (not shown) made of the resin material, and through cooling the mold while maintaining the inversion pattern to be pressed against a resin layer, thereby allowing the inversion pattern to be transferred to the resin layer.

The optical sheet 20 may be fabricated by the above manufacturing method or by an alternative method. For example, the optical sheet 20 may be fabricated by a manufacturing method (for example, the melting extrusion manufacturing method) in which elastic deformation, in which the distortion is likely to occur in the surface layer, is dominant. Also, the bonding area per unit area in an outer edge (an outer region) of the optical sheet 10 may be larger than the bonding area per unit area in a region other than the outer edge (the outer region) of the optical sheet 10. The bonding area per unit area means the bonding area between the optical sheet 10 and the optical sheet 20 when an area of a region facing the optical sheet 10 out of the bottom plane 20B of the optical sheet 20 is 1 (one), which is a so-called bonding area ratio. This makes it possible to prevent the peel (or delamination) from the edge of the optical sheet laminate body 1. Also, a pitch (a pitch in an arrangement direction) of the concave-convex portion (the projections and depressions) 11 formed on the top plane (the top surface) 10A of the optical sheet 10 is preferably 50 μm or less. Also, when an area of a region facing the optical sheet 10 out of the bottom plane 20B of the optical sheet 20 is 1 (one), the bonding area between the optical sheet 10 and the optical sheet 20 is preferably 0.055 or more in ratio. In other words, a ratio of a first area value to a second area value is 0.055 or more, where the first area value is a bonding area value of a region where the optical sheet 10 and the optical sheet 20 are bonded to each other, and the second area is an area of a region, which faces the optical sheet 10, of the bottom place 20B of the optical sheet 20. Moreover, when an area of a region facing the optical sheet 10 out of the bottom plane 20B of the optical sheet 20 is 1 (one), the bonding area between the optical sheet 10 and the optical sheet 20 is preferably 0.115 or less in ratio. In other words, a ratio of a first area value to a second area value is 0.115 or less. Those reasons will be described later in detail. Also, the bonding method of using the thermal lamination and the manufacturing method of the two optical sheets 10 and 20 will be described in detail in a later section of “Manufacturing Methods”.

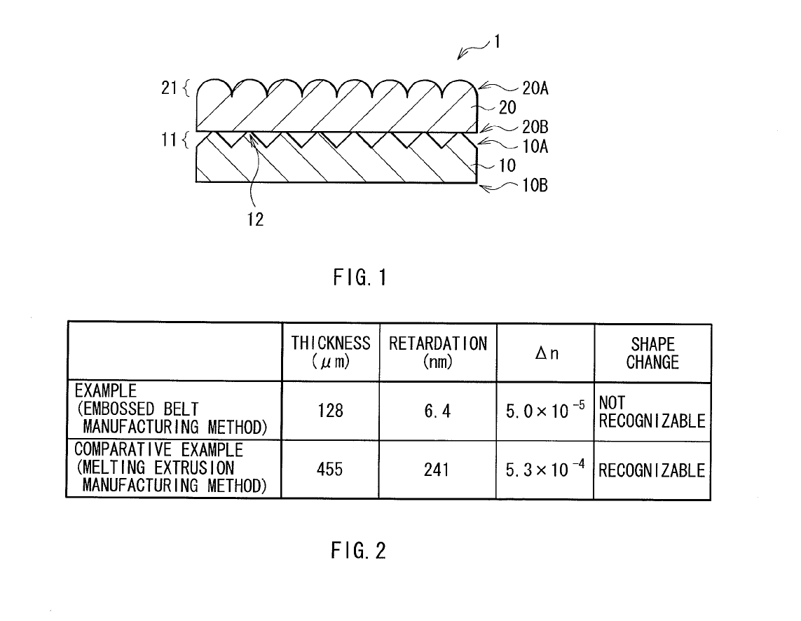

When the optical sheet is fabricated by the manufacturing method in which the plastic deformation is dominant (for example, an embossed belt method that will be described later), a birefringence value of its optical sheet becomes 5×10⁻⁵ or less. When the optical sheet is fabricated by the manufacturing method in which the elastic deformation is dominant (for example, the melting extrusion manufacturing method), a birefringence value of its optical sheet greatly exceeds 5×10⁻⁵ and becomes a value exceeding, for example, 5×10⁻⁴ (see FIG. 2).

The reason why the latter birefringence value is greater than the former birefringence value lies in the fact that in the manufacturing step in the latter manufacturing method, a great distortion is generated inside the resin layer by external force and stress, and its distortion causes the generation of a birefringence property. For example, in the melting extrusion manufacturing method, the resin in the melted state is poured in a shape of film into a roll-shaped master from a discharger. However, at the pouring step, the film-shaped resinous surface is cooled by air whose temperature is lower than the glass transition point. At this time, the film-shaped resinous surface is generally flat. Moreover, the resin is poured into the roll-shaped master. At this time, since the resin of the glass transition point or more is still present inside the resin, the resin is still soft, and the shape of the roll master is transferred. Here, since the roll-shaped master is lower than the glass transition point, the inside of the resin is also gradually cooled, and the shape is finally solidified. At this time, the distortion to return its concave-convex shape to the flat plane is accumulated on and near the resin surface into which the concave-convex shape is transferred. Thus, in the optical sheet fabricated by the melting extrusion manufacturing method, the birefringence property caused by its distortion is generated.

On the other hand, the reason why the former birefringence value is smaller than the latter birefringence value lies in the fact that in the manufacturing step of the former manufacturing method, the distortion caused by the external force and stress is hardly generated inside the resin layer, and the birefringence property caused by the distortion is hardly generated. For example, in the embossed belt method that will be described later, the surface of the resin film is heated at the temperature of the glass transition point or more by an embossed belt and a roll, and in the melted state, the embossed belt is pressed against its surface. At this time, in the resin film, the portion with which the embossed belt is brought into contact is in the melted state. Thus, in that portion, any distortion is not accumulated. Then, in a state in which the resin film and the embossed belt are tightly adhered to each other, the resin film is cooled to the temperature lower than the glass transition point. As a result, the concave-convex shape of the embossed belt is transferred into the surface of the resin film. At this time, any distortion is not accumulated on and near the resin surface into which the concave-convex shape is transferred, and the distortion to return its concave-convex shape to the flat plane is not present in the concave-convex shape of the resin film. Thus, the birefringence property caused by the distortion is not generated in the optical sheet fabricated by the embossed belt manufacturing method.

The birefringence caused by the distortion is classified into the induced birefringence and differs from an orientation birefringence caused by a selection orientation of molecules by stretching and the like. Thus, even if the optical sheet 10 (or the optical sheet 20) is fabricated by the manufacturing method in which the plastic deformation is dominant, there is a case that the orientation birefringence is generated in its optical sheet. At that time, when the birefringence of its optical sheet is measured, not only the induced birefringence but also the orientation birefringence is detected. Thus, whether its measured value is a value of the induced birefringence, or a value of the orientation birefringence, or a value of their compounds is not known. However, the induced birefringence is caused by the great distortion generated by the external force or stress. Hence, whether or not its measured value includes the induced birefringence is known by heating its optical sheet to the temperature of the glass transition temperature or more.

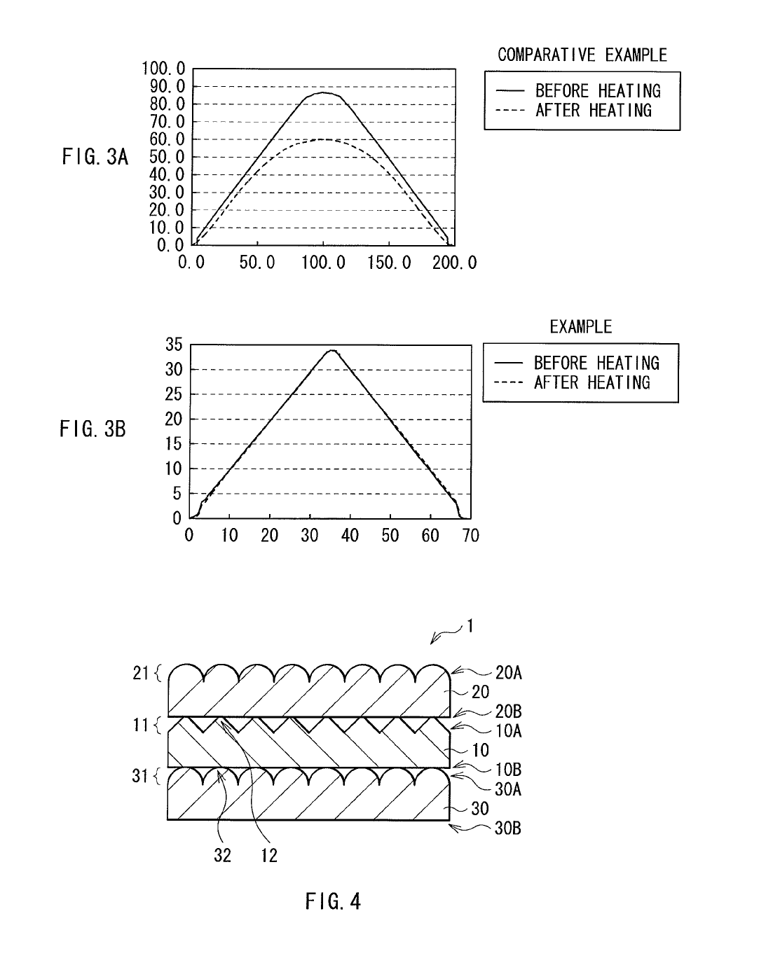

For example, when the optical sheet 10 (or the optical sheet 20) is heated at the temperature of the glass transition temperature or more so that the shape of the concave-convex portion 11 (or the concave-convex portion 21) is changed, it can be said that its measured value includes the induced birefringence. For example, when a certain optical sheet is heated at the temperature (for example, Tg+20 degrees centigrade) of the glass transition temperature or more for 10 seconds or more so that the concave-convex shape of its optical sheet is changed to the gentle concave-convex shape, the concave-convex shape is considered to be changed by the great distortion accumulated in its concave-convex portion. Thus, its measured value can be determined to include the induced birefringence. Actually, when the optical sheet fabricated by the melting extrusion manufacturing method was heated at the temperature (for example, Tg+20 degrees centigrade) of the glass transition temperature or more for one day, the concave-convex shape of its optical sheet (see a curve indicated as “Before Heating” of FIG. 3A) was changed to the gentle concave-convex shape (see a curve indicated as “After Heating” of FIG. 3A). Incidentally, depending on the thickness of the optical sheet, the concave-convex shape may be changed even in a heating time that is further shorter than the heating time as exemplified above.

Also, for example, when the shape of the concave-convex portion 11 (or the concave-convex portion 21) is not changed in the heating of the optical sheet 10 (or the optical sheet 20) at the temperature of the glass transition temperature or more, it can be said that its measured value does not include the induced birefringence. For example, when a certain optical sheet is heated at the temperature (for example, Tg +20 degrees centigrade) of the glass transition temperature or more for 10 seconds or more and the concave-convex shape of its optical sheet is not changed, the concave-convex shape is considered not to be changed because the distortion is not accumulated in its concave-convex portion. Thus, its measured value can be determined not to include the induced birefringence. Actually, when the optical sheet fabricated by the embossed belt manufacturing method was heated at the temperature (for example, Tg+20 degrees centigrade) of the glass transition temperature or more for one day, the concave-convex shape of its optical sheet (see a curve indicated as “Before Heating” of FIG. 3B) was hardly changed (see a curve indicated as “After Heating” of FIG. 3B).

To summarize the foregoing birefringence value precisely from the above explanation, the induced birefringence of its optical sheet becomes 5×10⁻⁵ or less when the optical sheet is fabricated by the manufacturing method in which the plastic deformation is dominant. On the other hand, when the optical sheet is fabricated by the manufacturing method in which the elastic deformation is dominant, the induced birefringence of its optical sheet greatly exceeds 5×10⁻⁵, and has a value exceeding, for example, 5×10⁻⁴.

### [Effect]

In this embodiment, the entire portion facing the bottom plane 20B of the optical sheet 20 out of the summit 12 of the concave-convex portion 11 of the optical sheet 10 and the entire portion facing the summit of the concave-convex portion 11 out of the bottom plane 20B of the optical sheet 20 are directly bonded to each other with the thermal lamination. More specifically, the summits 12 of the concave-convex portion 11 on the top plane 10A of the optical sheet 10 are directly bonded, in the whole region facing the bottom plane 20B of the optical sheet 20, to the bottom plane 20B of the optical sheet 20 without any intermediate material in between. In other words, the adhesive is not used to bond the optical sheet 10 and the optical sheet 20. Also, since the entire summit 12 of the concave-convex portion 11 is bonded to the bottom plane 20B of the optical sheet 20, an adherence property equivalent to that when the optical sheets 10 and 20 are attached to each other with the adhesive is obtained. Thus, it is possible to prevent the generation of the crinkle, the deflection, and/or the bowing, while attaining a thinner structure and lighter weight.

Also, in this embodiment, when at least the optical sheet 10 out of the optical sheet 10 and the optical sheet 20 is fabricated by the manufacturing method in which the plastic deformation is dominant and when the optical sheet 10 and the optical sheet 20 are bonded, it is possible to prevent the shape of the concave-convex portion 11 of the optical sheet 10 from being deformed or collapsed. Thus, in this case, the above-mentioned effects can be obtained without any substantial change in the optical characteristics.

### [Modifications]

### [First Modification]

The above-mentioned embodiment exemplifies the case that the concave-convex portion 21 of the optical sheet 20 has the shape (concave-convex shape) in which, for example, the plurality of convexes that are spherical, aspheric, curved, or multifaceted are two-dimensionally arranged, and that the optical sheet 20 has the light diffusion function entirely or partially. Here, this light diffusion function may be isotropic or anisotropic. When the light diffusion function is anisotropic, for example, each convex included in a concave-convex portion (asperities including projections and depressions) 31 has a shape anisotropy and a refractive index anisotropy in the plane. For example, each convex included in the concave-convex portion 31 has a different refractive index between the extending direction of each convex and the orientation direction of each convex.

Here, the in-plane anisotropy of the refractive index can be generated by stretching a sheet containing a semi-crystalline or crystalline resin in one direction. The semi-crystalline or crystalline resin includes a resin in which the refractive index in the stretching direction is larger than the refractive index in the direction orthogonal to the stretching direction, a resin in which the refractive index in the stretching direction is smaller than the refractive index in the direction orthogonal to the stretching direction, and the like. Examples of a material showing the positive birefringence in which the refractive index in the stretching direction becomes large include PET (poly-ethylene-telephthalate), PEN (poly-ethylene-naphthalate), a mixture thereof, a copolymer including PET-PEN copolymer, polycarbonate, polyvinyl alcohol, polyester, polyvinylidene fluoride, polypropylene, polyimide, and the like, for example. Examples of a material showing the negative birefringence in which the refractive index in the stretching direction becomes small include a methacryl resin, a polystyrene-based resin, a styrene-methyl methacrylate copolymer, a mixture thereof, and the like, for example.

The in-plane anisotropy of the refractive index can be generated by using, for example, a crystal material having the refractive index anisotropy. Also, in terms of simplifying the manufacturing process, the entire optical sheet 20 is preferably made of the same material. However, the concave-convex portion 21 may be made of a material different from that of other portions of the optical sheet 20.

### Second Modification

In the above-mentioned embodiment or the modification, each convex included in the concave-convex portion 11 of the optical sheet 10 may have a shape anisotropy and a refractive index anisotropy. In this case, the concave-convex portion 11 has a different refractive index between the extending direction of each convex and the orientation direction of each convex. A magnitude relation between the refractive index in the extending direction of each convex in the convexes of the concave-convex portion 11 and the refractive index in the orientation direction of each convex in each convex of the concave-convex portion 11, is preferably equal to a magnitude relation, for example, between the refractive index in the extending direction of each convex in each convex, of the concave-convex portion 21 and the refractive index in the orientation direction of each convex, in each convex of the concave-convex portion 21. Also, in this modification, the concave-convex portion 11 has the shape (concave-convex shape) in which, for example, the plurality of convexes that are spherical, aspheric, curved or multifaceted are two-dimensionally arranged.

### Third Modification

Also, in the above-mentioned embodiment and its modifications, the optical sheet laminate body 1 includes the two optical sheets. However, the optical sheet laminate body 1 may include the three or more optical sheets. In other words, the optical sheet laminate body 1 may have the two-layer structure or may have a multilayer structure of three or more layers. In that case, preferably, the two optical sheets adjacent to each other are directly bonded to each other with the thermal lamination.

For example, as shown in FIG. 4, an optical sheet 30 may be provided on the bottom plane 10B side of the optical sheet 10. This optical sheet 30 may be the rectangular resin sheet that has a top plane (a top surface) 30A and a bottom plane (a bottom surface) 30B. The bottom plane 10B of the optical sheet 10 and the top plane 30A of the optical sheet 30 face each other. The optical sheet 30 has a concave-convex portion (asperities including projections and depressions) 31 on the top plane 30A and a flat plane (a flat surface) on the bottom plane 30B, for example, as shown in FIG. 4. The top plane 30A may be flat without having the concave-convex portion 31.

The concave-convex portion 31 has the shape (concave-convex shape) in which, for example, the plurality of convexes that are spherical, aspheric, curved, or multifaceted are two-dimensionally arranged. The optical sheet 30 has the light diffusion function, for example, entirely or partially, and functions as the diffusion sheet. This light diffusion function may be isotropic or anisotropic.

The two optical sheets 30 and 10 are directly bonded to each other without any interposition of the intermediate material such as the adhesive. Specifically, the entire portion facing the bottom plane 10B of the optical sheet 10 out of a summit 32 of the concave-convex portion 31 and the entire portion facing the summit 32 of the concave-convex portion 31 out of the bottom plane 10B of the optical sheet 10 are directly bonded to each other with the thermal lamination. In other words, the summits 32 of the concave-convex portion 31 on the top plane 30A of the optical sheet 30 are directly bonded, in the whole region facing the bottom plane 10B of the optical sheet 10, to the bottom plane 10B of the optical sheet 10 without any intermediate material in between. Also, the optical sheet 30 is preferably fabricated by the manufacturing method in which the plastic deformation resistant to the occurrence of the distortion in the surface layer is dominant. For example, the optical sheet 30 may be fabricated through heating a mold (not shown) having an inversion pattern of the concave-convex portion (the asperities) 31 to a glass transition temperature of a resin material employed to form the optical sheet 30 or more, through pressing the inversion pattern against a resin layer (not shown) made of the resin material, and through cooling the mold while maintaining the inversion pattern to be pressed against a resin layer, thereby allowing the inversion pattern to be transferred to the resin layer. The manufacturing method of the optical sheet 30 will be described later in detail in a section of “Manufacturing Methods”.

### Fourth Modification

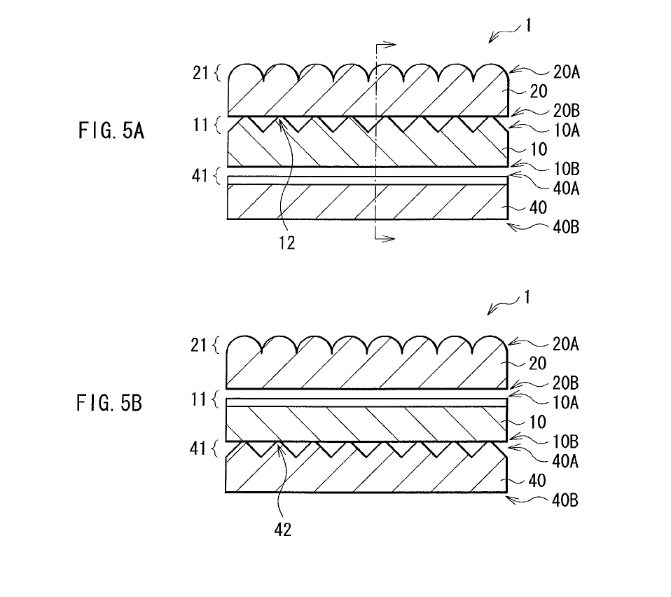

Also, the third modification exemplifies the case in which the third optical sheet functions as the diffusion sheet, although the third optical sheet may have other function. For example, as shown in FIGS. 5A and 5B, in the modification described above, an optical sheet 40 may be provided instead of the optical sheet 30.

This optical sheet 40 may be a rectangular resin sheet that has a top plane (a top surface) 40A and a bottom plane (a bottom surface) 40B. The bottom plane 10B of the optical sheet 10 and the top plane 40A of the optical sheet 40 face each other. The optical sheet 40 has a concave-convex portion 41 (asperities including projections and depressions) on the top plane 40A and a flat plane (a flat surface) on the bottom plane 40B, for example, as shown in FIGS. 5A and 5B.

For example, similarly to the concave-convex portion 11, the concave-convex portion 41 has the shape (concave-convex shape) in which the plurality of zonal prisms each having a triangular cross-section (triangular prisms) are arranged, for example. When the concave-convex portion 11 includes the triangular prism, the triangular prism included in the concave-convex portion 41 preferably extends in a direction crossing the extending direction of the triangular prism included in the concave-convex portion 11. When the concave-convex portion 41 has the shape in which the plurality of triangular prisms are arranged as mentioned above, the optical sheet 40 functions as the prism sheet for collecting the light incident from the bottom plane 40B side.

Similarly to the third modification, the two optical sheets 40 and 10 are directly bonded to each other with the thermal lamination or the like without any interposition of the intermediate material such as the adhesive. Also, similarly to the third modification, the optical sheet 40 is preferably fabricated by the manufacturing method in which the plastic deformation resistant to the occurrence of the distortion in the surface layer is dominant. The manufacturing method of the optical sheet 40 will be described later in detail in the section of “Manufacturing Methods”.

### Fifth Modification

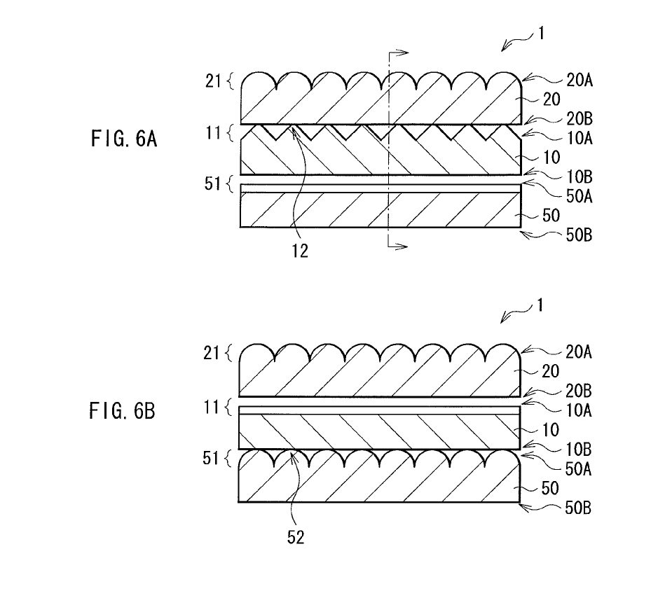

The fourth modification described above exemplifies the case in which the third optical sheet is the triangle prism sheet, although the third optical sheet may be a prism sheet having other shape. For example, as shown in FIGS. 6A and 6B, in the fourth modification described above, an optical sheet 50 may be provided instead of the optical sheet 40.

This optical sheet 50 may be a rectangular resin sheet that has a top plane (a top surface) 50A and a bottom plane (a bottom surface) 50B. The bottom plane 10B of the optical sheet 10 and the top plane 50A of the optical sheet 50 face each other. The optical sheet 50 has a concave-convex portion (asperities including projections and depressions) 51 on the top plane 50A and a flat plane (a flat surface) on the bottom plane 50B, for example, as shown in FIGS. 6A and 6B.

The concave-convex portion 51 has the shape (concave-convex shape) in which the plurality of zonal prisms each having an aspheric surface (aspheric prisms) are arranged, for example. When the concave-convex portion 11 includes the triangular prism, the aspheric prism included in the concave-convex portion 51 preferably extends in a direction crossing the extending direction of the triangular prism included in the concave-convex portion 11. When the concave-convex portion 51 has the shape in which the plurality of aspheric prisms are arranged as mentioned above and the concave-convex portion 51 is provided only on the top plane 50A side and also the bottom plane 50B is flat, the optical sheet 50 functions as the prism sheet for modifying an emission angle of light, which is to be emitted from the top plane 50A, to a predetermined angle, while improving the luminance irregularity of the light incident from the bottom plane 50B side.

Similarly to the third modification, the two optical sheets 50 and 10 are directly bonded to each other with the thermal lamination or the like without any interposition of the intermediate material such as the adhesive. Also, similarly to the third modification, the optical sheet 50 is preferably fabricated by the manufacturing method in which the plastic deformation resistant to the occurrence of the distortion in the surface layer is dominant. The manufacturing method of the optical sheet 50 will be described later in detail in the section of “Manufacturing Method”.

### Second Embodiment

### [Structure]

FIG. 7 shows an example of a sectional configuration of an optical sheet laminate body 2 according to the second embodiment. This optical sheet laminate body 2 is preferably used in the illumination unit and the backlight of the display unit, and the like, and includes a plurality of optical sheets. Hereafter, the same reference numerals are given to the same configuration elements as the elements shown in the above-mentioned embodiment and its modifications.

The optical sheet laminate body 2 has a configuration in which, for example, as shown in FIG. 7, four optical sheets 10, 70, 60, and 20 are laminated in this order. The optical sheet 60 may be a rectangular resin sheet that has a top plane (a top surface) 60A and a bottom plane (a bottom surface) 60B. The optical sheet 60 has the flat planes (flat surfaces) on both of the top plane 60A and the bottom plane 60B, for example, as shown in FIG. 7. The optical sheet 60 is, for example, a reflection polarization sheet (reflective polarizer).

The reflection polarization sheet has a multilayer structure in which, for example, layers whose refractive indexes differ from each other, are alternately laminated, and is configured to ps-separate the light whose directivity is made high by the optical sheet 10, and also pass only a p-wave and selectively reflect an s-wave. The reflected s-wave is again reflected by, for example, a reflection sheet of the illumination unit (not shown), and divided into the p-wave and the s-wave at that time. Thus, the s-wave reflected by the reflection polarization sheet can be used again. This reflection polarization sheet may be further formed such that the multilayer structure is sandwiched with the diffusion sheet. Consequently, the p-wave transmitted through the multilayer film is diffused with the diffusion sheet inside the reflection polarization sheet so that the view angle can be made wide. This reflection polarization sheet has the rigidity of the degree at which only the multilayer structure is hardly deflected by the heat from the light source. However, when the reflection polarization sheet has the lamination structure in which the multilayer structure is sandwiched with the diffusion sheet, the rigidity is further improved, which does not cause the deflection. Incidentally, a design desirable for improving the luminance as the diffusion sheet lies in a design in which a haze value on an exit side after the incidence from a light source incidence side becomes small (a backward scattering haze value becomes smaller than a forward scattering haze value). For example, a structure in which a plurality of convex lens arrays are provided on the light exit side is desirable. When the backward scattering haze value consequently becomes smaller than the forward scattering haze value, it contributes to the improvement of the luminance.

The optical sheet 70 is, for example, a plane sheet. This optical sheet 70 is inserted such that, in relation to the optical sheet 60, a thickness H2 of the optical sheet on the top plane 60A side and a thickness H1 of the optical sheet on the bottom plane 60B side are equal to or approximately equal to each other. Thus, when a thickness of the optical sheet 20 and a thickness of the optical sheet 10 are equal to or approximately equal to each other, this optical sheet 70 may be omitted.

When the materials (or linear expansion coefficients) of the optical sheet on the top plane 60A side and the optical sheet on the bottom plane 60B side are equal to or approximately equal to each other, the thickness H2 of the optical sheet on the top plane 60A side and the thickness H1 of the optical sheet on the bottom plane 60B side are preferably equal to or approximately equal to each other in the relation to the optical sheet 60. Also, when the materials (or linear expansion coefficients) of the optical sheet on the top plane 60A side and the optical sheet on the bottom plane 60B side differ from each other, the respective thicknesses H1 and H2 are preferably set appropriately based on the magnitude relation between the linear expansion coefficients. For example, when the linear expansion coefficient of the optical sheet on the top plane 60A side is larger than the linear expansion coefficient of the optical sheet on the bottom plane 60B side, the thickness H2 of the optical sheet on the top plane 60A side is preferably thinner than the thickness H1 of the optical sheet on the bottom plane 60B side.

However, the above is applicable to the case in which the material (or linear expansion coefficient) of the optical sheet 60 and the materials (or linear expansion coefficients) of the optical sheet on the top plane 60A side and the optical sheet on the bottom plane 60B side differ from each other.

The optical sheets 20, 60, the optical sheets 60, 70, and the optical sheets 70, 10 are directly bonded to each other with the thermal lamination or the like without any interposition of the intermediate material such as the adhesive, respectively, similarly to the above-mentioned embodiment. Optionally, the intermediate material such as the adhesive may be used to bond a part of them.

### [Effect]

In this embodiment, at least one set of the optical sheets out of the two optical sheets 20, 60, the two optical sheets 60, 70, and the two optical sheets 70, are directly bonded to each other with the thermal lamination. In other words, the adhesive is not used in bonding the optical sheets. Also, since the entire summit of the concave-convex portion or the entire facing portion is bonded, the adherence property equivalent to that when the optical sheets are attached to each other with the adhesive is obtained. Thus, it is possible to prevent the generation of the crinkle, the deflection, and/or the bowing, while attaining a thinner structure and lighter weight.

Also, in this embodiment, when at least the optical sheet 10 out of the optical sheets 10, 20, 60, and 70 is fabricated by the manufacturing method in which the plastic deformation is dominant and when the optical sheet 10 and the optical sheet 70 (the optical sheet 60 when the optical sheet 70 is omitted) are bonded, it is possible to prevent the shape of the concave-convex portion 11 of the optical sheet 10 from being deformed or collapsed. Thus, in this case, the above effects can be obtained without any substantial change in the optical characteristics.

### Third Embodiment

### [Structure]

FIG. 8 shows an example of a sectional configuration of an optical sheet laminate body 3 according to the third embodiment. This optical sheet laminate body 3 is preferably used in the illumination unit and the backlight of the display unit, and the like, and includes the plurality of optical sheets. The optical sheet laminate body 3 has a configuration in which, for example, as shown in FIG. 8, the three optical sheets 30, 80, and 20 are laminated in this order. The optical sheet 80 may be a rectangular resin sheet that has a top plane (a top surface) 80A and a bottom plane (a bottom surface) 80B. The optical sheet 80 has a concave-convex portion (asperities including projections and depressions) 81 on the top plane 80A and a flat plane (a flat surface) on the bottom plane 80B, for example, as shown in FIG. 8. The concave-convex portion 81 may be provided also on the bottom plane 80B, or a concave-convex portion different from the concave-convex portion 81 may be provided.

The concave-convex portion 81 is provided on the entire top plane 80A or partially thereof (for example, a region except an edge in the top plane 80A), and has a shape (concave-convex shape) in which a plurality of zonal prisms each having a triangular cross-section (triangular prisms) are arranged, for example. When the concave-convex portion 81 has the shape in which the plurality of triangular prisms are arranged as mentioned above, the optical sheet 80 functions as the prism sheet for collecting the light incident from the bottom plane 80B side.

When the materials (or linear expansion coefficients) of the optical sheet on the top plane 80A side and the optical sheet on the bottom plane 80B side are equal to or approximately equal to each other, a thickness H2 of the optical sheet on the top plane 80A side and a thickness H1 of the optical sheet on the bottom plane 80B side are preferably equal to or approximately equal to each other in the relation to the optical sheet 80. Also, when the materials (or linear expansion coefficients) of the optical sheet on the top plane 80A side and the optical sheet on the bottom plane 80B side differ from each other, the respective thicknesses H1 and H2 are preferably set appropriately based on the magnitude relation between the linear expansion coefficients. For example, when the linear expansion coefficient of the optical sheet on the top plane 80A side is larger than the linear expansion coefficient of the optical sheet on the bottom plane 80B side, the thickness H2 of the optical sheet on the top plane 80A side is preferably thinner than the thickness H1 of the optical sheet on the bottom plane 80B side.

However, the above is applicable to the case in which the material (or linear expansion coefficient) of the optical sheet 80 and the materials (or linear expansion coefficients) of the optical sheet on the top plane 80A side and the optical sheet on the bottom plane 80B side differ from each other.

The optical sheets 20, 80 and the optical sheets 80, 30 are directly bonded to each other with the thermal lamination or the like without any interposition of the intermediate material such as the adhesive, respectively, similarly to the above-mentioned embodiments. Optionally, the intermediate material such as the adhesive may be used to bond a part of them.

### [Effect]

In this embodiment, at least one set of the optical sheets out of the two optical sheets 20, 80 and the two optical sheets 80, 30 are directly bonded to each other with the thermal lamination. In other words, the adhesive is not used in bonding the optical sheets. Also, since the entire summit of the concave-convex portion is bonded, the adherence property equivalent to that when the optical sheets are attached to each other with the adhesive is obtained. Thus, it is possible to prevent the generation of the crinkle, the deflection, and/or the bowing, while attaining a thinner structure and lighter weight.

Also, in this embodiment, when at least the optical sheets 30 and 80 out of the optical sheets, 20, 30, and 80 are fabricated by the manufacturing method in which the plastic deformation is dominant and when the optical sheet 30 and the optical sheet 80 are bonded and the optical sheet 80 and the optical sheet 20 are bonded, it is possible to prevent the shapes of the concave-convex portions 31 and 81 of the optical sheets 30 and 80 from being deformed or collapsed. Thus, in this case, the above effects can be obtained without any substantial change in the optical characteristics.

### [Modification]

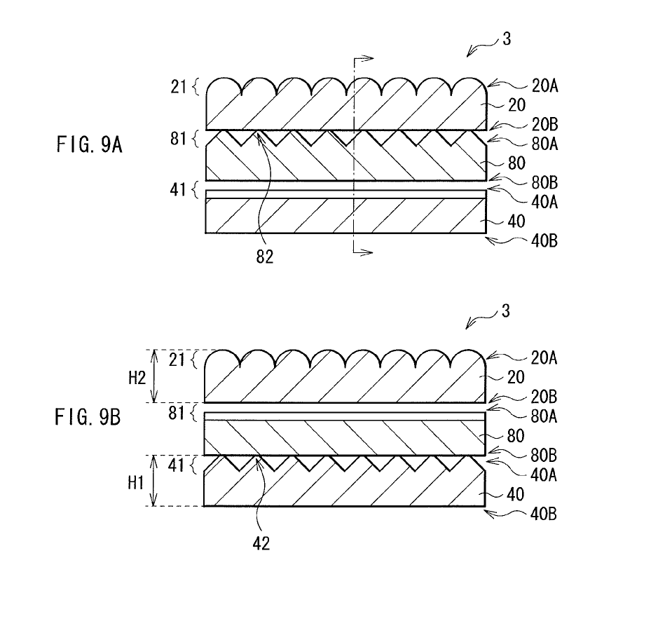

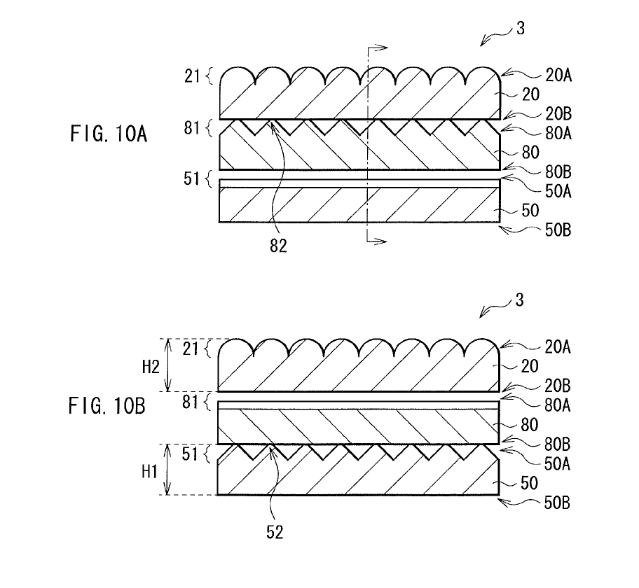

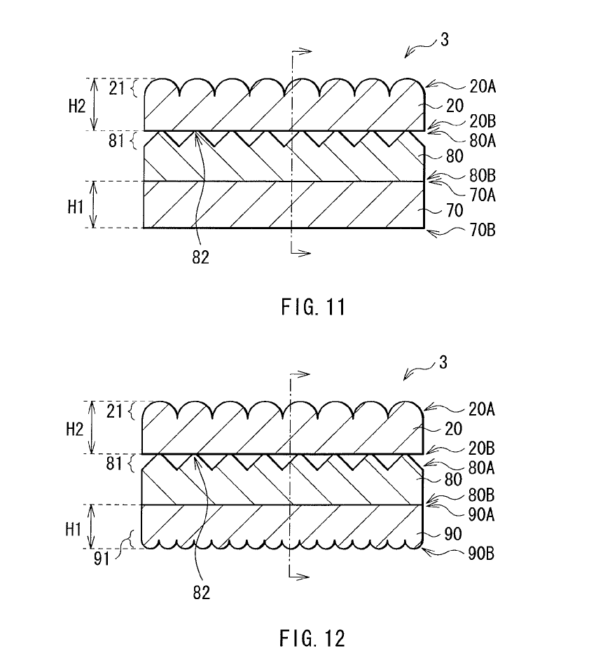

In the third embodiment, although the optical sheet 30 is used as the third optical sheet, an optical sheet different therefrom may be used. For example, as shown in FIGS. 9A and 9B, in the third embodiment described above, the optical sheet 40 may be provided instead of the optical sheet 30. Also, for example, as shown in FIGS. 10A and 10B, in the third embodiment described above, the optical sheet 50 may be used instead of the optical sheet 30. Also, for example, as shown in FIG. 11, in the third embodiment described above, the optical sheet 70 may be used instead of the optical sheet 30. Also, for example, as shown in FIG. 12, in the third embodiment described, an optical sheet 90 may be provided instead of the optical sheet 30. The optical sheet 90 corresponds to an optical sheet in which a concave-convex portion (asperities including projections and depressions) 91 is provided on a rear of the optical sheet 70. In this way, by providing the concave-convex portion 91 on the rear of the optical sheet 70, it is possible to obtain the various advantages such as the improvement of the luminance irregularity (luminance non-uniformity), the improvement of the view angle, and the improvement of a damage resistance property.

### [Manufacturing Methods]

Example of the manufacturing methods of the optical sheet laminate bodies 1 to 3 and the optical sheets 10 to 90 according to the above-mentioned respective embodiments and theirs modifications will be hereinafter described.

### [Embossed Belt Manufacturing Method]

FIG. 13A shows a schematic configuration of a manufacturing device 100 of an optical sheet 170 that corresponds to the optical sheet having the concave-convex portions on the surface out of the optical sheets 10 to 90. This manufacturing device 100 is a device capable of carrying out the embossed belt manufacturing method which is one of manufacturing methods in which the plastic deformation is dominant. This manufacturing device 100 includes a heating roll 110, a cooling roll 120, a nip roll 130, a guide roll 140, and an embossed belt 150, for example, as shown in FIG. 13A.

The embossed belt 150 is for transferring a shape on a surface of a resin sheet 160 that will be described later. The embossed belt 150 includes a concave-convex portion (asperities including projections and depressions) 150A on its outer surface. The concave-convex portion 150A has a shape in which the concave-convex shape to be transferred on the surface of the optical sheet 170 is inverted. The concave shape or convex shape included in a convex portion 140A extends in, for example, a movement direction of the outer surface of the embossed belt 150 (the circumferential direction of the embossed belt 150). The concave shape or convex shape included in the concave-convex portion 150A may extend in, for example, a direction crossing the circumferential direction of the embossed belt 150.

The heating roll 110 is arranged on the rear of the embossed belt 150 (the side opposite to the concave-convex portion 150A), and is configured to operate and heat the embossed belt 150. The cooling roll 120 is arranged on the rear of the embossed belt 150 (the side opposite to the concave-convex portion 150A), and is configured to operate and cool the embossed belt 150. The nip roll 130 and the guide roll 140 are arranged on the outer side of the embossed belt 150 (on the concave-convex portion 150A side), and are arranged to face the embossed belt 150 through a predetermined gap. The nip roll 130 is arranged to face the heating roll 110 through the embossed belt 150, and the guide roll 140 is arranged to face the cooling roll 120 through the embossed belt 150. A gap 180 formed between the nip roll 130 and the embossed belt 150 has a size of a degree at which the nip roll 130, together with the heating roll 110, is able to press a later-described resin sheet 160 against the embossed belt 150 at a predetermined pressure. The nip roll 130 also serves to heat the resin sheet 160.

Here, the embossed belt 150 is heated on the heating roll 110 side, and its temperature T₁ is equal to or higher than the glass transition temperature of the resin sheet 160. Also, the embossed belt 150 is cooled on the cooling roll 120 side, and its temperature T₂ is lower than the glass transition temperature of the resin sheet 160. For example, the heating roll 110 and the nip roll 130 carry out the heating operation at a temperature (Tg+ΔT) higher than the glass transition temperature (Tg) of the resin sheet 160. Since its heat is transmitted through the embossed belt 150, the temperature T₁ on the heating roll 110 side in the embossed belt 150 is equal to or higher than the glass transition temperature of the resin sheet 160. Also, for example, the cooling roll 120 is cooled to the temperature lower than the glass transition temperature (Tg) of the resin sheet 160. Since the embossed belt 150 is cooled by the cooling roll 120, the temperature T₂ on the cooling roll 120 side in the embossed belt 150 is lower than the glass transition temperature of the resin sheet 160.

In the manufacturing device 100 having the foregoing configuration, the resin sheet 160 such as a plane sheet is sent from an unillustrated roll, and inserted into the gap 180, and the resin sheet 160 is pressed at the gap 180 against the concave-convex portion 150A by the heating roll 110 and the nip roll 130. As a result, at least the surface on the embossed belt 150 side of the resin sheet 160 is melted because its temperature exceeds the glass transition temperature (Tg) of the resin sheet 160. The resin sheet 160 is moved on the embossed belt 150, for a while, in a state in which its state is kept. Thereafter, the temperature of the resin sheet 160 becomes lower than the glass transition temperature (Tg) of the resin sheet 160 when it is somewhat separated from the heating roll 110. As a result, the surface on the embossed belt 150 side of the resin sheet 160 is solidified, and the inversion shape of the concave-convex portion 150A (the concave-convex portion 170A) is transferred on the resin sheet 160. Thereafter, the resin sheet 160 on which the inversion shape of the concave-convex portion 150A is transferred is peeled or detached from the embossed belt 150. In this way, the optical sheet 170 having the concave-convex portion 170A is manufactured.

In the manufacturing device 100 described above, in peeling or detaching the optical sheet 170 from the embossed belt 150, the optical sheet 170 may be bent, as shown in FIG. 13A, or the optical sheet 170 may be straightly pulled without being bent, for example, as shown in FIG. 13B. At this time, an endless belt 190 for supporting the resin sheet 160, and guide rolls 191 and 192 for operating the endless belt 190 may be provided on the bottom plane of the resin sheet 160. Also, the optical sheet 170 may be manufactured using a different manufacturing method in which the plastic deformation is dominant. Examples of the manufacturing method in which the plastic deformation is dominant include an injection molding method, a thermal press molding method, and the like, other than the above embossed belt manufacturing method.

Effects obtained by the above manufacturing method will be hereinafter described. In the above manufacturing method, at least the surface on the embossed belt 150 side out of the optical sheet 170 is heated at the temperature of the glass transition point or more by the embossed belt 150 and the heating rolls 110 and 130, and the embossed belt 150 is pressed against its surface in the melted state thereof. At this time, since the portion with which the embossed belt 150 out of the optical sheet 170 is brought into contact is in the melted state, any distortion is not accumulated or substantially not accumulated in that portion. Thereafter, in the state in which the optical sheet 170 and the embossed belt 150 are tightly attached to each other, the optical sheet 170 is cooled to the temperature lower than the glass transition point. As a result, the shape of the concave-convex portion 150A of the embossed belt 150 is transferred on the surface of the optical sheet 170. At this time, any distortion is not accumulated or substantially not accumulated on and near the surface of the optical sheet 170 on which the shape of the concave-convex portion 150A is transferred, and the distortion to return its concave-convex shape to the flat plane is not present or is not substantially present in the concave-convex portion 170A of the optical sheet 170. For this reason, even if the optical sheet 170 is heated at the temperature (for example, Tg+20 degrees centigrade) of the glass transition temperature or more of the optical sheet 170 for 10 seconds, the shape of the concave-convex portion 170A of the optical sheet 170 is not collapsed or not substantially collapsed. Thus, when the summit of the concave-convex portion 170A of the optical sheet 170 is bonded to the different optical sheet, the deformation or the collapsing of the shape of the concave-convex portion 170A can be suppressed to the minimum.

### [Thermal Lamination Manufacturing Method]

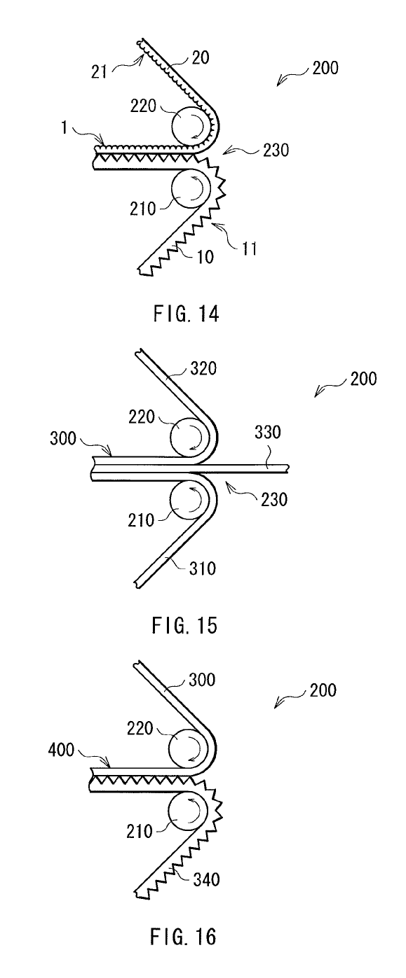

FIG. 14 shows a schematic configuration of a manufacturing device 200 of the optical sheet laminate bodies 1 to 3. FIG. 14 schematically shows a state when the manufacturing device 200 manufactures the optical sheet laminate body 1.

FIG. 14 shows an exemplary state in which the concave-convex portion 11 of the optical sheet 10 extends in a width direction of the manufacturing device 200 (a direction vertical to a paper surface). However, concave-convex portion 11 of the optical sheet 10 may extend in a flow direction of the manufacturing device 200. This manufacturing device 200 includes two heating rolls 210 and 220. The two heating rolls 210 and 220 are arranged through a predetermined gap.

The heating roll 210 serves to send the upper optical sheet (for example, the optical sheet 20) to a gap 230 between the two heating rolls 210 and 220, and to press the same against the lower optical sheet (for example, the optical sheet 10). The heating roll 220 serves to send the lower optical sheet to the gap 230, and to press the same against the upper optical sheet. Moreover, the two heating rolls 210, 220 carry out the heating operation at the temperature of the glass transition temperature or more of the upper optical sheet and the lower optical sheet, and melt the portion in which the upper optical sheet and the lower optical sheet are brought into contact with each other in the gap 230.

In the manufacturing device 200 having the foregoing configuration, the lower optical sheet is sent from a not-shown roll and inserted through the heating roll 210 into the gap 230. Meanwhile, the upper optical sheet is sent from a not-shown roll and inserted through the heating roll 220 into the gap 230. Then, in the gap 230, the lower optical sheet and the upper optical sheet are pressed and heated by the heating rolls 210 and 220. As a result, the portion in which the upper optical sheet and the lower optical sheet are in contact with each other exceeds the temperature of the glass transition temperature or more of the upper optical sheet and the lower optical sheet, and is thus melted. The upper optical sheet and the lower optical sheet that are in contact with each other in the melted state are gradually cooled after they exit the gap 230, and their temperatures become lower than the glass transition temperatures of the upper optical sheet and the lower optical sheet. As a result, the portion in which the upper optical sheet and the lower optical sheet are melted is solidified, and the upper optical sheet and the lower optical sheet are bonded to each other. In this way, the optical sheet 170 is manufactured.

[Manufacturing Method when Optical Sheets of Three Layers are Laminated]

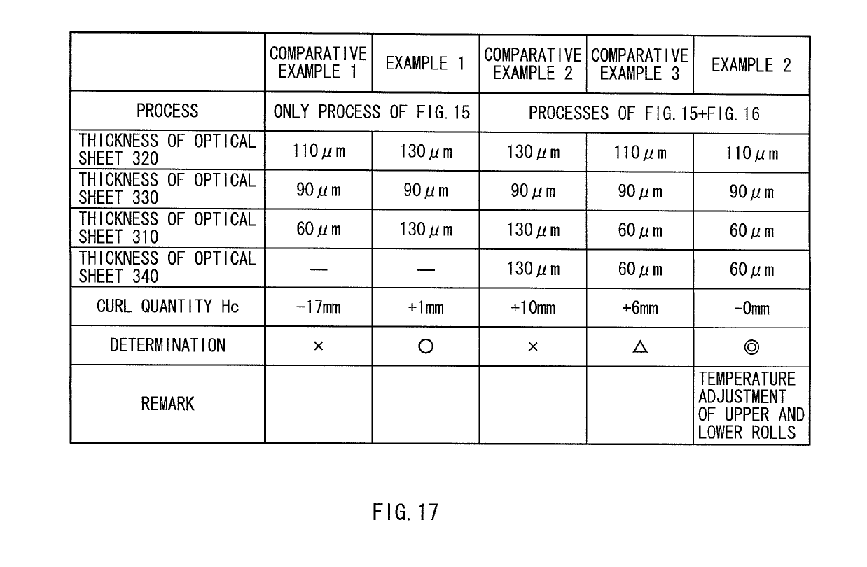

FIG. 15 shows an example of a method of bonding the optical sheets of three layers at the same time to manufacture an optical sheet laminate body 300, in the manufacturing device 200 described above.

First, a lower optical sheet 310 is sent from a not-shown roll and inserted through the heating roll 210 into the gap 230. An upper optical sheet 320 is sent from a not-shown roll and inserted through the heating roll 220 into the gap 230. Moreover, an intermediate optical sheet 330 is sent from a not-shown roll and inserted between the optical sheet 310 and the optical sheet 320. Then, in the gap 230, the optical sheets 310, 320, and 330 are pressed and heated by the heating rolls 210 and 220. As a result, the portion in which the optical sheet 310 and the optical sheet 320 are in contact with each other exceeds the temperature of the glass transition temperature or more of the optical sheets 310 and 320, and is melted. Moreover, the portion in which the optical sheet 320 and the optical sheet 330 are in contact with each other exceeds the temperature of the glass transition temperature or more of the optical sheets 320 and 330, and is melted. The optical sheets 310, 320, and 330 in contact with each other in the melted state are gradually cooled after they exit the gap 230, and their temperatures become lower than those glass transition temperatures. As a result, the melted portion of the optical sheet 310 and the optical sheet 320 is solidified, and the optical sheet 310 and the optical sheet 320 are bonded to each other. Moreover, the melted portions of the optical sheet 320 and the optical sheet 330 are solidified, and the optical sheet 320 and the optical sheet 330 are bonded to each other. In this way, the optical sheet laminate body 300 is manufactured.

The above manufacturing method is effective especially when the optical sheets whose materials or linear expansion coefficients differ from each other are to be bonded. For example, let us suppose that the material (or linear expansion coefficient) of the optical sheet 330 and the material (or linear expansion coefficient) of the optical sheets 310 and 320 differ from each other. The optical sheet 330 is made of, for example, stretched polyethylene naphthalate (PEN), and the optical sheets 310 and 320 are made of, for example, polycarbonate. The linear expansion coefficients of the optical sheets 310 and 320 are 7×10⁻⁵/degrees centigrade in both of the flow direction and the width direction of the manufacturing device 200. The linear expansion coefficient of the optical sheet 330 is 8×10⁻⁵/degrees centigrade in the flow direction of the manufacturing device 200 and 4×10⁻⁵/degrees centigrade in the width direction of the manufacturing device 200. The linear expansion coefficients of the optical sheets 310 and 320 and the linear expansion coefficient of the optical sheet 330 are greatly different in the width direction of the manufacturing device 200. When the optical sheets 310, 320, and 330 having the foregoing characteristics are bonded at the same time using the foregoing manufacturing method, the difference in the linear expansion coefficients enables the generation of the crinkle, the deflection, and/or the bowing to be reduced. When this optical sheet laminate body 300 is manufactured, the optical sheets 310 and 320 are preferably manufactured in advance by using the foregoing embossed belt manufacturing method.

[Manufacturing Method when Optical Sheets of Four Layers are Laminated]

FIG. 16 shows an example of a method of manufacturing an optical sheet laminate body 400 by bonding the optical sheet laminate body 300 and an optical sheet 340, in the above manufacturing device 200. FIG. 16 exemplifies a state in which the concave-convex portion of the optical sheet 340 extends in the width direction of the manufacturing device 200 (a direction vertical to a paper surface). However, the concave-convex portion of the optical sheet 340 may extend in the flow direction of the manufacturing device 200.

First, the optical sheet 340 is sent from a not-shown roll and inserted through the heating roll 210 into the gap 230. Meanwhile, the optical sheet laminate body 300 is sent from a not-shown roll and inserted through the heating roll 220 into the gap 230. Then, in the gap 230, the optical sheet 340 and the optical sheet laminate body 300 are pressed and heated by the heating rolls 210 and 220. As a result, the portion in which the optical sheet 340 and the optical sheet laminate body 300 are in contact with each other exceeds the temperature of the glass transition temperature or more of the optical sheet 340 and the optical sheet 310 inside the optical sheet laminate body 300, and is melted. The optical sheet 340 and the optical sheet laminate body 300 in contact with each other in the melted state are gradually cooled after they exit the gap 230, and their temperatures become lower than the glass transition temperatures of the optical sheet 340 and the optical sheet 310 inside the optical sheet laminate body 300. As a result, the portion in which the optical sheet 340 and the optical sheet laminate body 300 are melted is solidified, and the optical sheet 340 and the optical sheet laminate body 300 are bonded to each other. In this way, the optical sheet laminate body 400 is manufactured.

### [Curl Quantity]

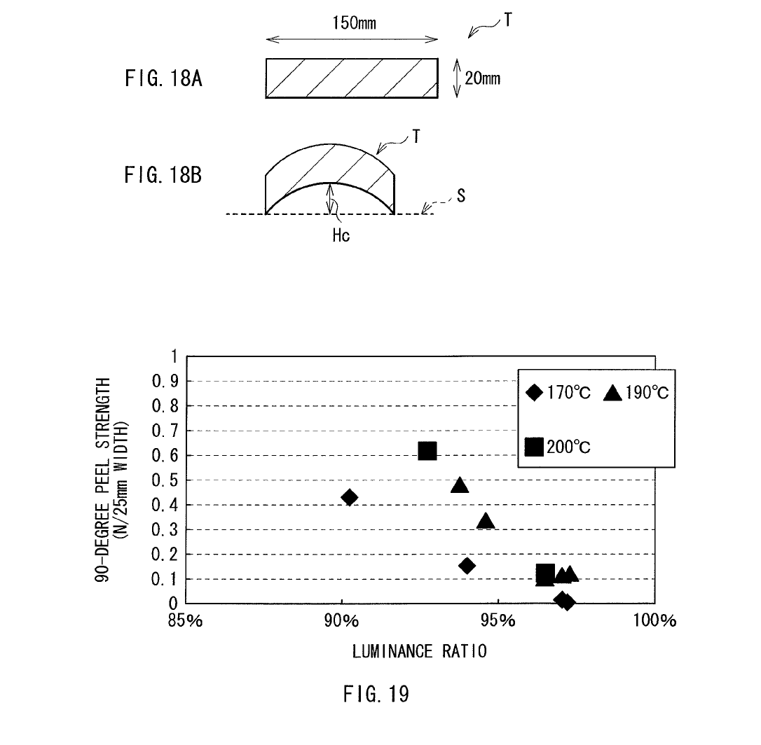

A curl quantity Hc of the optical sheet laminate body fabricated by each of the above manufacturing methods will be hereinafter described. FIG. 17 shows the thicknesses and the curl quantities Hc of the respective optical sheets included in the optical sheet laminate bodies according to comparative examples 1, 2, and 3 and the optical sheet laminate bodies according to examples 1 and 2. The curl quantity Hc is obtained by measuring a bowing quantity (see FIG. 18B) when a test sample T in which each optical sheet laminate body is cut to a size shown in FIG. 18A is placed on a flat plane S.

From FIG. 17, it can be seen that the curl quantity Hc is small, when a balance of a thickness between the PCs (the optical sheets 310 and 320) bonded to the fronts and the rears, respectively, is symmetrical with the stretched PEN (optical sheet 330) as a center (the example 1). Also, even when the thermal lamination is carried out in two stages, it can be seen that the curl quantity Hc is relatively small, when the balance between the thickness of the PC (optical sheet 320) bonded to the front and the PCs (convex portions 310 and 340) bonded to the rear is symmetrical with the stretched PEN (optical sheet 330) as a center (the comparative example 3). Moreover, it can be seen that the curl quantity Hc is drastically small, when in the process of FIG. 15, the temperatures of the heating rolls 210 and 220 are made different and they are set to the suitable conditions (the example 2). In the comparative examples 1, 2, and 3 and the example 1, the temperatures of the heating rolls 210 and 220 were set to the same temperature (160 degrees centigrade), whereas in the example 2, the temperature of the heating roll 220 was set to the temperature (170 degrees centigrade) higher than the temperature (140 degrees centigrade) of the heating roll 210.

In the manufacturing process shown in FIGS. 14 to 16, before the optical sheets 10, 20, 310, 320, and 340 and the optical sheet laminate body 300 are bonded with the thermal lamination, they are preferably brought into contact with the heating rolls 210 and 220 in advance. When a heat temperature is applied to the optical sheets 10, 20, 310, 320, and 340 and the optical sheet laminate body 300, they are expanded. However, when their expansion quantities are great, stresses are applied thereto at the time of bonding, which causes the curling. For this reason, it is preferable that, before they are bonded, the optical sheets 10, 20, 310, 320, and 340 and the optical sheet laminate body 300 be preliminarily heated and expanded so as to prevent the stresses from being applied thereto when they are bonded.

Also, when the upper and lower films are made of the same material, the temperatures of the upper and lower heating rolls 210 and 220 are preferably equal to each other, since this allows the expansion quantities of the upper and lower films to be made equal. Also, when the upper and lower films are made of the materials different from each other, the temperatures of the upper and lower heating rolls 210 and 220 are preferably adjusted such that the expansion quantities of the upper and lower films are made equal to each other.

### [Peel]

The above-manufactured optical sheet laminate body is cut to a predetermined shape and size using, for example, a Thomson blade or Victoria blade, in order to provide the same in the backlight of the liquid crystal display unit, etc. At this time, when the bonding strength between the respective optical sheets inside the optical sheet laminate body is insufficient, the optical sheet may be peeled or delaminated when it is cut. Also, when the bonding strength between the respective optical sheets inside the optical sheet laminate body is insufficient, the mechanical strength of the optical sheet laminate body may also be insufficient, which may make the handling of the optical sheet laminate body difficult.

A magnitude of the bonding strength mainly depends on the bonding area per unit area. It may be thus contemplated to increase the bonding area per unit area. However, when the bonding area per unit area is increased over the optical sheet in mutually bonding the summit of the concave-convex portion of one optical sheet and the rear (flat plane) of the other optical sheet, there is a possibility that the concave-convex shape of the concave-convex portion is excessively deformed or collapsed, which may result in the change (deterioration) in the optical characteristics.

Hence, in such a case, the bonding area per unit area is preferably changed between the outer edge (the outer region) of the optical sheet and a region other than the outer edge (the outer region) of the optical sheet. Specifically, the optical sheets are preferably bonded to each other, so that the bonding area per unit area in the outer edge (the outer region) of the optical sheet becomes larger than that in the region other than the outer edge (the outer region) of the optical sheet. This makes it possible to suppress the change in the concave-convex shape in the region except the outer edge of the optical sheet, which has severe influence on the optical characteristics, to the minimum, and to further increase the bonding strength between the optical sheets.

Incidentally, in a process step such as the handling and blanking, the peel of the optical sheet laminate body is generated with a slight peel or delamination generated in the outer edge portion of the optical sheet laminate body as a trigger. This is because, when the partial parts (only the summits) of the optical sheets are bonded to each other, the peel strength when the optical sheet laminate body is pulled while being bent (the peel strength in a case of a bent angle of 180 degrees) is weaker than the peel strength (sharing tensile strength) when the optical sheet laminate body is pulled in the in-plane direction. Thus, as mentioned above, when the bonding strength of the outer edge portion of the optical sheet laminate body is made strong so as to make the peel from its portion difficult, the possibility that the peel is generated in the optical sheet laminate body is reduced, even if the bonding strength of the portion except the outer edge of the optical sheet laminate body is weak.

In the outer edge portion of the optical sheet laminate body, when the rate of the bonding portion is increased as compared with the central portion of the optical sheet laminate body, a display property may be different between the central portion and the outer edge portion. For this reason, the portion in which the bonding strength is made strong is preferably provided in a portion that is not opposed to an effective pixel region (display region) of the display panel. Currently, an optical sheet provided in a marketed liquid crystal display unit has a size in which both of a horizontal direction and a vertical direction are about 20 mm with respect to a display region of a display panel. Thus, the portion in which the bonding strength is made strong is preferably provided in a range of 10 mm or less from the edge of the optical sheet.

### [Various Evaluations]

Optical sheet laminate bodies used to perform the following various evaluations will be hereinafter described. Each of the optical sheet laminate bodies used was the optical sheet laminate body having a two-layer structure in which the two optical sheets configured of PC were bonded. As the lower optical sheet, a prism sheet was used in which a plurality of bar-shaped convexes (projections) each having a cross-section of an isosceles right triangle were arranged in parallel inside an upper plane. The upper optical sheet was a diffusion sheet in which a plurality of substantially hemispherical convexes were two-dimensionally arranged inside the upper plane. The three optical sheet laminate bodies were prepared in which the pitches between the convexes of the lower optical sheets were 40, 50, and 70 μm, respectively. The lower optical sheet and the upper optical sheet were fabricated using the foregoing embossed belt manufacturing method.

For each of the three kinds of the optical sheet laminate bodies, the luminance, the peel strength, and the bonding width were measured.

In measuring the luminance, BM-7 available from Topcon Corporation of Tokyo, Japan was used. In the following, the luminance of each of the three kinds of the optical sheet laminate bodies is represented in a luminance ratio, in which each luminance of the laminate bodies of the lower optical sheet and the upper optical sheet is 100% before the three kinds of the optical sheet laminate bodies are manufactured.

As for the bonding strength, after a part of the lower optical sheet and that of the upper optical sheet were peeled, a peel tester was used to pull the upper optical sheet so that an angle between the upper optical sheet and the lower optical sheet became 90 degrees. Herein, when the pulling force is weak, the peel of the optical sheet laminate body does not progress, although when the pulling force exceeds a certain tension strength, the peel progresses. The critical peel strength thereof was measured as a 90-degree peel strength. The higher the value of the peel strength, the better the peel strength. However, in order to prevent the peel from being generated in the optical sheet laminate body in the handling, the peel strength of 0.2 N/25 mm width is sufficient. Also, in order to prevent the peel from being generated in the optical sheet laminate body in the blanking step, the critical peel strength of 1 N/25 mm width or more is sufficient. When the optical sheet laminate body is made so as not to generate the peel in the blanking step, it is possible to mutually bond the optical sheets with the rolls and blank the optical sheet laminate body obtained by the bonding thereafter. This is preferable in terms of improved industrial productivity.

The bonding width was obtained by measuring the cut plane of the optical sheet laminate body with an optical microscope. Here, a width of a portion, in the summit of the convex of the lower optical sheet, in contact with the bottom plane of the upper optical sheet was defined as the bonding width.

FIG. 19 shows a heating roll temperature dependence in a relation between the luminance ratio and a 90-degree peel strength. In FIG. 19, a pitch between the convexes in the lower optical sheet was 50 μm. It can be seen from FIG. 19 that, when the temperatures of the heating rolls 210 and 220 were changed from 170 degrees centigrade to 190 degrees centigrade and to 200 degrees centigrade and when the temperatures of the heating rolls 210 and 220 were at 190 degrees centigrade and 200 degrees centigrade, both of the luminance ratio and the peel strength were at the preferable values, as compared with the case in which the temperatures of the heating rolls 210 and 220 were at 170 degrees centigrade. Therefore, for the PC film, it can be said that the temperatures (namely, the bonding temperature) of the heating rolls 210 and 220 are preferably 190 degrees or more.

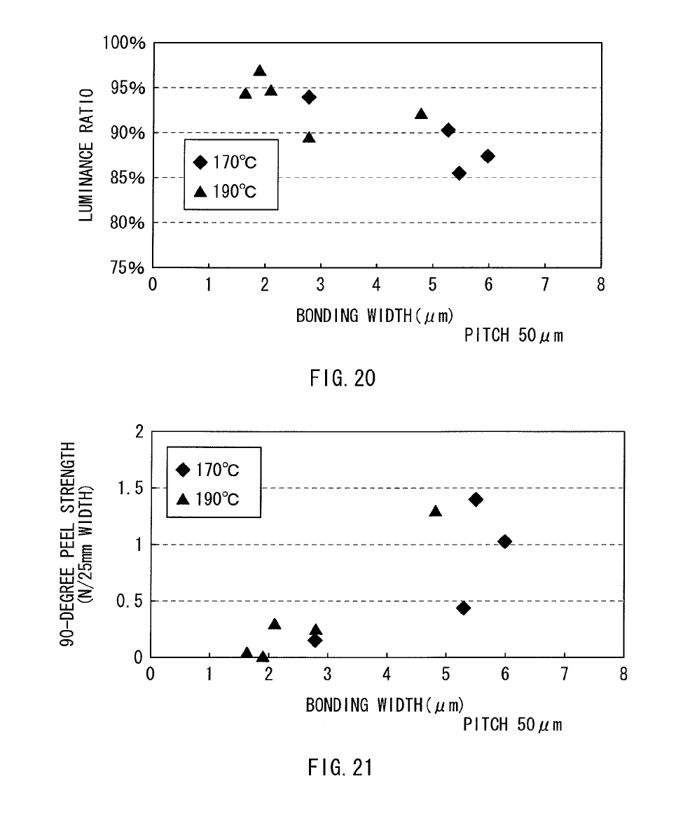

FIG. 20 shows a heating roll temperature dependence in a relation between the bonding width and the luminance ratio. From FIG. 20, it was found that the luminance ratio became lower as the bonding width became wider. However, there was no change resulting from the temperatures of the heating rolls 210 and 220.

FIG. 21 shows a heating roll temperature dependence in a relation between the bonding width and the 90-degree peel strength. From FIG. 21, it was found that the peel strength became stronger as the bonding width became wider. Also, from FIG. 21, it was found that, when the temperatures of the heating rolls 210 and 220 were at 190 degrees centigrade, the peel strength became strong, in the same bonding width, as compared with the case in which the temperatures of the heating rolls 210 and 220 were at 170 degrees centigrade. Therefore, it was found that it is possible to increase the peel strength by bonding them at the high temperature, even if the bonding width was narrow. In other words, it can be said that it is possible to increase the adherence (adhesion) by bonding them at the high temperature.

The following can be said when the quality of the adherence (adhesion) is microscopically considered. At the time of the bonding, the polymers exceeding the glass transition point cross each other, and after the bonding, they are returned to a room temperature and tightly adhered to each other. When the temperature is near the glass transition point at the time of the bonding, the energy of the polymer is low, and a molecular motion is not vigorous, for example. Also, the kinetic energy of the polymer is low as compared with the intermolecular force between the polymers, so that the twining style of the polymers on the boundary between the optical sheets is not sufficient. In contrast, when the bonding temperature is high, the kinetic energy of the polymer is also high, and thus it can be said that more robust bonding is attained on the boundary since the high motional state and vibrating state are created. Therefore, it can be said that it is the energy state of the polymer that determines the quality of the adherence (adhesion), which is determined by a difference of temperature from the glass transition point. The glass transition point of the PC is 150 degrees centigrade. Thus, when they are bonded at the temperature (190 degrees centigrade) which is higher than the glass transition point by 40 degrees centigrade or more, the quality of the adherence (adhesion) improves, and the preferable bonding state is attained.

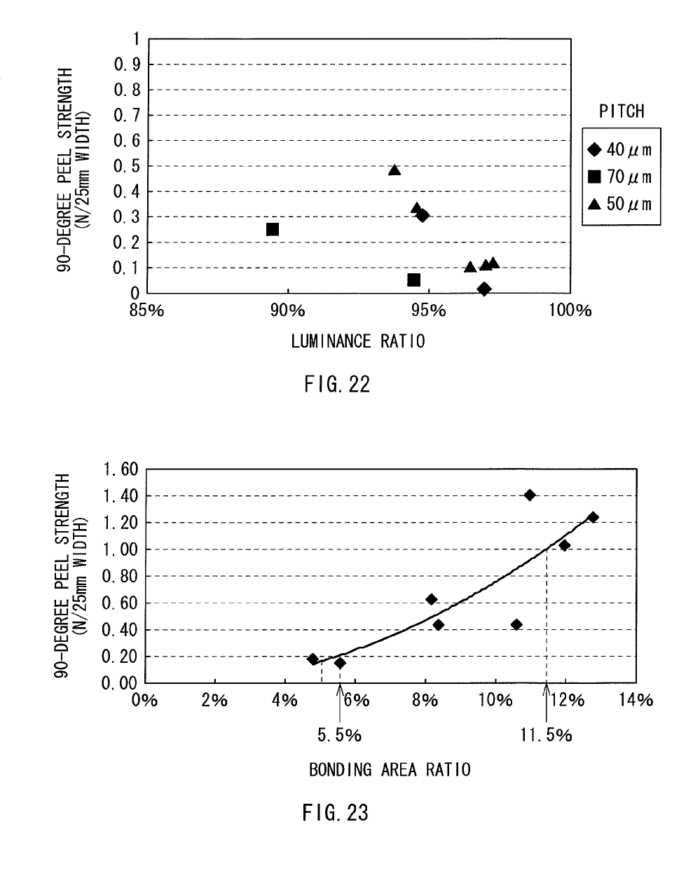

FIG. 22 shows a concave-convex pitch dependence, in the relation between the luminance ratio and the 90-degree peel strength, when the temperatures of the heating rolls 210 and 220 were constantly set to 190 degrees centigrade and the pitch between the convexes of the lower optical sheet was set to 40 μm, 50 μm, and 70 μm. From FIG. 22, it can be seen that, when the pitch between the convexes of the lower optical sheet was set to 40 μm and 50 μm, both of the luminance ratio and the peel strength were at the preferable values, as compared with the case in which the pitch between the convexes the lower optical sheet was set to 70 μm. Therefore, it can be said that the pitch between the convexes of the lower optical sheet is preferably 50 μm or less. This results from the following reasons. The luminance is uniquely determined on the basis of the bonding area. In contrast, the peel strength does not perfectly correspond to the bonding area. The peel strength changes depending on the quality of the adherence (adhesion) as mentioned above and also changes depending on the pitch between the convexes of the lower optical sheet as shown in FIG. 21. The change in the peel strength caused by the pitch between the convexes of the lower optical sheet is describable as follows. The bonding area is determined by “Area of One bonding Portion”×“Number of bonding Portions”. Even if the bonding areas are the same, the peel strength is structurally higher when the number of the bonding portions is greater. Therefore, the pitch between the convexes (projections) of the lower optical sheet is preferably 50 μm or less.

FIG. 23 shows a relation between the bonding area per unit area (bonding area ratio) and the 90-degree peel strength, when the temperatures of the heating rolls 210 and 220 were constantly set to 190 degrees centigrade and the pitch between the convexes of the lower optical sheet was set to 50 μm. As mentioned above, in order to prevent the peel from being generated in the optical sheet laminate body in the handling, the peel strength of 0.2 N/25 mm width is sufficient. Also, in order to prevent the peel from being generated in the optical sheet laminate body in the blanking step, the critical peel strength of 1 N/25 mm width or more is sufficient. From FIG. 23, to obtain the peel strength of 0.2 N/25 mm width at which the peel is not generated in the optical sheet laminate body in the handling, the bonding area ratio may be 0.055 (5.5%) or more. Also, from FIG. 23, to obtain the peel strength of 1.0 N/25 mm width at which the peel is not generated in the optical sheet laminate body in the blanking step, the bonding area ratio may be 0.115 (11.5%) or more.

### APPLICATION EXAMPLES

Application examples of the optical sheet laminate bodies 1 to 3, 300, and 400 according to the above-mentioned respective embodiments and their modifications will be hereinafter described.

### First Application Example

For example, as shown in FIGS. 24A and 24B, any one of the optical sheet laminate bodies 1 to 3, 300, and 400, and a diffusion plate 500 having a thickness of 1 mm or more that is typically used in an illumination unit, may be integrated by a bonding portion 510 provided in a circumference thereof. This makes it possible to obtain a higher rigidity. As the bonding method through the use of the bonding portion 510, it is possible to use a method which does not use an intermediate material, such as a thermal welding, a thermal compressive bonding, and an ultrasonic welding. A method that uses the intermediate material such as the adhesive may be used. The adhesive may be, for example but not limited to, PSA (pressure sensitive adhesive).

### Second Application Example

FIG. 25 shows a sectional configuration of a display unit 600 according to this application example. The display unit 600 is provided with: a liquid crystal display panel 610 driven on the basis of an image signal; a light source 620 arranged behind the liquid crystal display panel 610; and a diffusion plate 630 and any one of the optical sheet laminate bodies 1 to 3, 300, and 400 which are arranged between the liquid crystal display panel 610 and the light source 620. Optionally, the diffusion plate 630 may be omitted. The liquid crystal display panel 610 corresponds to an illustrative example of a “display panel” according to an embodiment.

The liquid crystal display panel 610 has a lamination structure including a liquid crystal layer between a transparent substrate on an image display side and a transparent substrate on the light source 620 side, which are not shown. Specifically, the liquid crystal display panel 610 has a polarization plate, a transparent substrate, a color filter, a transparent electrode, an alignment film, a liquid crystal layer, an alignment film, a transparent pixel electrode, a transparent substrate, and a polarization plate, in order from the image display side.

The polarization plates each serve as a kind of an optical shutter and pass only the light (polarization) of a constant oscillation direction. Those polarization plates are arranged such that the respective polarization axes differ from each other by 90 degrees. Consequently, the light emitted from the light source 620 transmits through the liquid crystal layer or blocked. The transparent plate is made of a substrate transparent to visible light, which may be a sheet glass, for example. A drive circuit of an active type, which includes TFT (Thin Film Transistor) serving as a drive element electrically connected to the transparent pixel electrode, wirings etc, is formed in the transparent substrate on the light source 620 side. The color filter has a configuration in which the color filters for separating the light emitted from the light source 620 into the three primary colors of, for example, red (R), green (G), and blue (B), respectively, are arranged. The transparent electrode is made of, for example, ITO (Indium Tin Oxide), and functions as a common opposed electrode. The alignment film is made of, for example, a polymer material such as polyimide, and performs an alignment process on the liquid crystal. The liquid crystal layer is made of the liquid crystal of, for example, a VA (Vertical Alignment) mode, and has a function to transmit or block the light emitted from the light source 620 for each pixel by a voltage applied from the drive circuit. The transparent pixel electrode is made of, for example, ITO, and functions as the electrode for each pixel.

The light source 620 illuminates the liquid crystal display panel 610 through any one of the optical sheet laminate bodies 1 to 3, 300, and 400. The light source 620 has a configuration in which, for example, a plurality of linear light sources are arranged at an equal interval (for example, 20 μm interval) in parallel. The linear light source may be a cold cathode fluorescent lamp that is typically referred to as a cold cathode fluorescent lamp (CCFL). However, a hot cathode fluorescent lamp (HCFL) may be employed. Also, the linear light source may have a configuration in which point-like light sources, such as light emitting diodes (LED), are straightly arranged. Each of the linear light sources is arranged to extend in a direction parallel to the extending direction of the concave-convex portion of the lowest optical sheet in a plane parallel to the bottom plane of any one of the optical sheet laminate bodies 1 to 3, for example.

In this application example, since any one of the optical sheet laminate bodies 1 to 3 is used, there is hardly any decrease in the optical characteristics caused by the crinkle, deflection, and/or bowing of the optical sheet. Thus, it is possible to provide the display unit having the high display quality. Also, as the result of the use of any one of the optical sheet laminate bodies 1 to 3, the entire display unit 600 can be made thin, which enables the display unit 600 to be light in weight.

Although the invention has been described in the foregoing by way of example with reference to the embodiments, the modifications, and the application examples, the invention is not limited thereto but may be modified in a wide variety of ways. For example, the above-mentioned embodiments, modifications, and application examples may be mutually combined to implement such a combination. Also, the optical sheet according to each of the embodiments, the modifications, and the application examples includes or also refers to a “film-shaped optical element (or an “optical film”)”.

Although the present application has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in this disclosure is intended to be dedicated to the public regardless of whether the element or component is explicitly recited in the following claims.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical sheet laminate body comprising:
a first optical sheet having a top surface and a bottom surface, of which at least the top surface has asperities including projections and depressions; and
a second optical sheet having a top surface and a bottom surface,
wherein summits of the projections on the top surface of the first optical sheet are directly bonded, in a whole region facing the bottom surface of the second optical sheet, to the bottom surface of the second optical sheet without any intermediate material in between.

2. The optical sheet laminate body according to claim 1, wherein an induced birefringence value of the first optical sheet is 5×10⁻⁵ or less.

3. The optical sheet laminate body according to claim 1, wherein the first optical sheet is formed through heating a mold having an inversion pattern of the asperities to a glass transition temperature of a resin material employed to form the first optical sheet or more, through pressing the inversion pattern against a resin layer made of the resin material, and through cooling the mold while maintaining the inversion pattern to be pressed against a resin layer, thereby allowing the inversion pattern to be transferred to the resin layer.

4. The optical sheet laminate body according to claim 1, wherein a bonding area per unit area in an outer region of the first optical sheet is larger than that in a region other than the outer region of the first optical sheet.

5. The optical sheet laminate body according to claim 1, wherein a pitch of the projections and depressions formed on the top surface of the first optical sheet is 50 μm or less.

6. The optical sheet laminate body according to claim 1, wherein a ratio of a first area value to a second area value is 0.055 or more, where the first area value is a bonding area value of a region where the first optical sheet and the second optical sheet are bonded to each other, and the second area is an area of a region, which faces the first optical sheet, of the bottom surface of the second optical sheet.

7. The optical sheet laminate body according to claim 6, wherein a ratio of a first area value to a second area value is 0.115 or less.

8. An optical sheet laminate body comprising:
a first optical sheet having a top surface and a bottom surface, of which at least the top surface is flat; and
a second optical sheet having a top surface and a bottom surface, of which at least the bottom surface is flat,
wherein the top surface of the first optical sheet are directly bonded, in a whole region facing the bottom surface of the second optical sheet, to the bottom surface of the second optical sheet without any intermediate material in between.

9. The optical sheet laminate body according to claim 1, wherein the first optical sheet and the second optical sheet are made of the same material.

10. The optical sheet laminate body according to claim 9, wherein the first optical sheet and the second optical sheet include polycarbonate.

11. The optical sheet laminate body according to claim 1, wherein the first optical sheet and the second optical sheet are made of materials differing from each other, and
either one of the first and second optical sheets, the one having a higher thermal expansion coefficient, is thinner than the other.

12. The optical sheet laminate body according to claim 11, further comprising a third optical sheet arranged on a opposite side of the second optical sheet from the first optical sheet, the third optical sheet having a thermal expansion coefficient substantially equal to that of the first optical sheet,
wherein a surface on a second-optical-sheet side of the third optical sheet is directly bonded to a surface on a third-optical-sheet side of the second optical sheet without any intermediate material in between.

13. The optical sheet laminate body according to claim 12, wherein the second optical sheet is a reflective polarizer.

14. A manufacturing method of an optical sheet laminate body, comprising:
preparing a first optical sheet and a second optical sheet, the first optical sheet having a top surface and a bottom surface, of which at least the top surface has asperities including projections and depressions, and the second optical sheet having a top surface and a bottom surface; and
directly bonding summits of the projections on the top surface of the first optical sheet, in a whole region facing the bottom surface of the second optical sheet, to the bottom surface of the second optical sheet without any intermediate material in between.

15. The manufacturing method of the optical sheet laminate body according to claim 14, wherein, in the preparing of the first optical sheet and the second optical sheet, the first optical sheet is formed through heating a mold having an inversion pattern of the asperities to a glass transition temperature of a resin material employed to form the first optical sheet or more, through pressing the inversion pattern against a resin layer made of the resin material, and through cooling the mold while maintaining the inversion pattern to be pressed against a resin layer, thereby allowing the inversion pattern to be transferred to the resin layer.

16. An illumination unit comprising:
the optical sheet laminate body according to claim 1; and
a light source emitting light toward the optical sheet laminate body.

17. A display unit comprising:
the optical sheet laminate body according to claim 1;
a display panel driven based on an image signal; and
a light source illuminating the display panel via the optical sheet laminate body.
